(19) United States
(12) Patent Application Publication
(10) Pub. No.: US 2014/0236678 A1
(43) Pub. Date: Aug. 21, 2014

(54) SYSTEMS AND METHODS TO ENHANCE SEARCH VIA TRANSACTION DATA

(71) Applicant: Visa International Service Association, San Francisco, CA (US)

(72) Inventors: Kevin Akerman, Orinda, CA (US); Vipul Bahety, Sunnyvale, CA (US); Michelle Eng Winters, Belmont, CA (US); Jinping Gong, Foster City, CA (US); Charles Raymond Byce, Mill Valley, CA (US)

(73) Assignee: Visa International Service Association, San Francisco, CA (US)

(21) Appl. No.: 13/900,420

(22) Filed: May 22, 2013

Related U.S. Application Data
(60) Provisional application No. 61/766,284, filed on Feb. 19, 2013.

(51) Int. Cl. G06F 17/30

(52) U.S. Cl. CPC G06F 17/30864; G06Q 30/0205
USPC 705/7.34

(57) ABSTRACT

A computing apparatus is configured to: receive a search term from a user; identify a region within which a residence location of the user is located; obtain a spending profile generated based on aggregating transaction data of users residing in the region; and customize a search result based on the spending profile. For examples, spending of users residing in different regions (e.g., identified via zip+4 postal codes) can be aggregated within respective regions, and normalized and/or ranked across the regions to generate spending preference indicators. Further, the average distances between the residence locations of users residing with different regions and merchant locations at which the users make transactions using payment accounts are determined for the respective regions. The spending indicators and the average distance are used to select, prioritize and/or customize search results to reflect the spending preferences of users based on the residence regions of the users.

### RELATED APPLICATION

The present application claims priority to Prov. U.S. Pat. App. Ser. No. 61/766,284, filed Feb. 19, 2013 and entitled “Systems and Methods to Enhance Search via Transaction data”, the entire disclosure of which is hereby incorporated herein by reference.

The present application relates to U.S. patent application Ser. Nos. 12/940,664 and 12/940,562, both filed Nov. 5, 2010, and U.S. patent application Ser. No. 13/675,301, filed Nov. 13, 2012 and entitled “Systems and Methods to Summarize Transaction data”, the entire disclosures of which applications are hereby incorporated herein by reference.

### FIELD OF THE TECHNOLOGY

At least some embodiments of the present disclosure relate to the processing of transaction data, such as records of payments made via credit cards, debit cards, prepaid cards, etc., and/or providing information based on the processing of the transaction data.

### BACKGROUND

Millions of transactions occur daily through the use of payment cards, such as credit cards, debit cards, prepaid cards, etc. Corresponding records of the transactions are recorded in databases for settlement and financial record keeping (e.g., to meet the requirements of government regulations). Such data can be mined and analyzed for trends, statistics, and other analyses. Sometimes such data are mined for specific advertising goals, such as to provide targeted offers to account holders, as described in PCT Pub. No. WO 2008/067543 A2, published on Jun. 5, 2008 and entitled “Techniques for Targeted Offers.”

U.S. Pat. App. Pub. No. 2009/0216579, published on Aug. 27, 2009 and entitled “Tracking Online Advertising using Payment Services,” discloses a system in which a payment service identifies the activity of a user using a payment card as corresponding with an offer associated with an online advertisement presented to the user.

U.S. Pat. No. 6,298,330, issued on Oct. 2, 2001 and entitled “Communicating with a Computer Based on the Offline Purchase History of a Particular Consumer,” discloses a system in which a targeted advertisement is delivered to a computer in response to receiving an identifier, such as cookie, corresponding to the computer.

U.S. Pat. No. 7,035,855, issued on Apr. 25, 2006 and entitled “Process and System for Integrating Information from Disparate Databases for Purposes of Predicting Consumer Behavior,” discloses a system in which consumer transactional information is used for predicting consumer behavior.

U.S. Pat. No. 6,505,168, issued on Jan. 7, 2003 and entitled “System and Method for Gathering and Standardizing Customer Purchase Information for Target Marketing,” discloses a system in which categories and sub-categories are used to organize purchasing information by credit cards, debit cards, checks and the like. The customer purchase information is used to generate customer preference information for making targeted offers.

U.S. Pat. No. 7,444,658, issued on Oct. 28, 2008 and entitled “Method and System to Perform Content Targeting,” discloses a system in which advertisements are selected to be sent to users based on a user classification performed using credit card purchasing data.

U.S. Pat. App. Pub. No. 2005/0055275, published on Mar. 10, 2005 and entitled “System and Method for Analyzing Marketing Efforts,” discloses a system that evaluates the cause and effect of advertising and marketing programs using card transaction data.

U.S. Pat. App. Pub. No. 2008/0217397, published on Sep. 11, 2008 and entitled “Real-Time Awards Determinations,” discloses a system for facilitating transactions with real-time awards determinations for a cardholder, in which the award may be provided to the cardholder as a credit on the cardholder's statement.

The disclosures of the above discussed patent documents are hereby incorporated herein by reference.

### BRIEF DESCRIPTION OF THE DRAWINGS

The embodiments are illustrated by way of example and not limitation in the figures of the accompanying drawings in which like references indicate similar elements.

FIG. 1 illustrates a system to provide services based on transaction data according to one embodiment.

FIG. 2 illustrates the generation of an aggregated spending profile according to one embodiment.

FIG. 3 shows a method to generate an aggregated spending profile according to one embodiment.

FIG. 4 shows a system to provide information based on transaction data according to one embodiment.

FIG. 5 illustrates a transaction terminal according to one embodiment.

FIG. 6 illustrates an account identifying device according to one embodiment.

FIG. 7 illustrates a data processing system according to one embodiment.

FIG. 8 shows the structure of account data for providing loyalty programs according to one embodiment.

FIG. 9 shows a system to obtain purchase details according to one embodiment.

FIG. 10 shows a system to provide profiles to target advertisements according to one embodiment.

FIG. 11 shows a method to provide a profile for advertising according to one embodiment.

FIG. 12 shows a method to summarize transaction data for geographic regions according to one embodiment.

FIG. 13 illustrates a profile for a geographic region according to one embodiment.

FIG. 14 shows a method to generate region profiles according to one embodiment.

FIG. 15 shows a system to enhance search via transaction data according to one embodiment.

FIG. 16 shows a method to enhance search via transaction data according to one embodiment.

### DETAILED DESCRIPTION

### Introduction

In one embodiment, transaction data, such as records of transactions made via credit accounts, debit accounts, prepaid accounts, bank accounts, stored value accounts and the like, is processed to provide information for various services, such as reporting, benchmarking, advertising, content or offer selection, customization, personalization, prioritization, etc. In one embodiment, users are required to enroll in a service program and provide consent to allow the system to use related transaction data and/or other data for the related services. The system is configured to provide the services while protecting the privacy of the users in accordance with the enrollment agreement and user consent.

For example, based on the transaction data, an advertising network in one embodiment is provided to present personalized or targeted advertisements/offers on behalf of advertisers. A computing apparatus of, or associated with, the transaction handler uses the transaction data and/or other data, such as account data, merchant data, search data, social networking data, web data, etc., to develop intelligence information about individual customers, or certain types or groups of customers. The intelligence information can be used to select, identify, generate, adjust, prioritize, and/or personalize advertisements/offers to the customers. The transaction handler may be further automated to process the advertisement fees charged to the advertisers, using the accounts of the advertisers, in response to the advertising activities.

In one embodiment, a set of profiles are generated from the transaction data for a plurality of geographical regions, such as mutually exclusive, non-overlapping regions defined by postal codes. In one embodiment, transactions of account holders residing in the regions are aggregated according to merchant categories for the respective regions and subsequently normalized to obtain preference indicators that reveal the spending preferences of the account holders in the respective regions. In one embodiment, each of the profiles for respective regions are based on a plurality of different account holders and/or households to avoid revealing private information about individual account holders or families. Further, the profiles are constructed in a way to make it impossible to reverse calculate the transaction amounts. Further details and examples about profiles constructed for regions in one embodiment are provided in the section entitled “AGGREGATED REGION PROFILE.”

In one embodiment, aggregated region profiles are used in the presentation and customization of search results. For example, in response to a search request from a user, an aggregated region profile applicable to the user is obtained and used to prioritize and/or select search results in accordance with the information about users residing in the region summarized by the aggregated region profile. Further details and examples about the use of aggregated region profiles in the enhancement of searches are in one embodiment are provided in the section entitled “SEARCH.”

### System

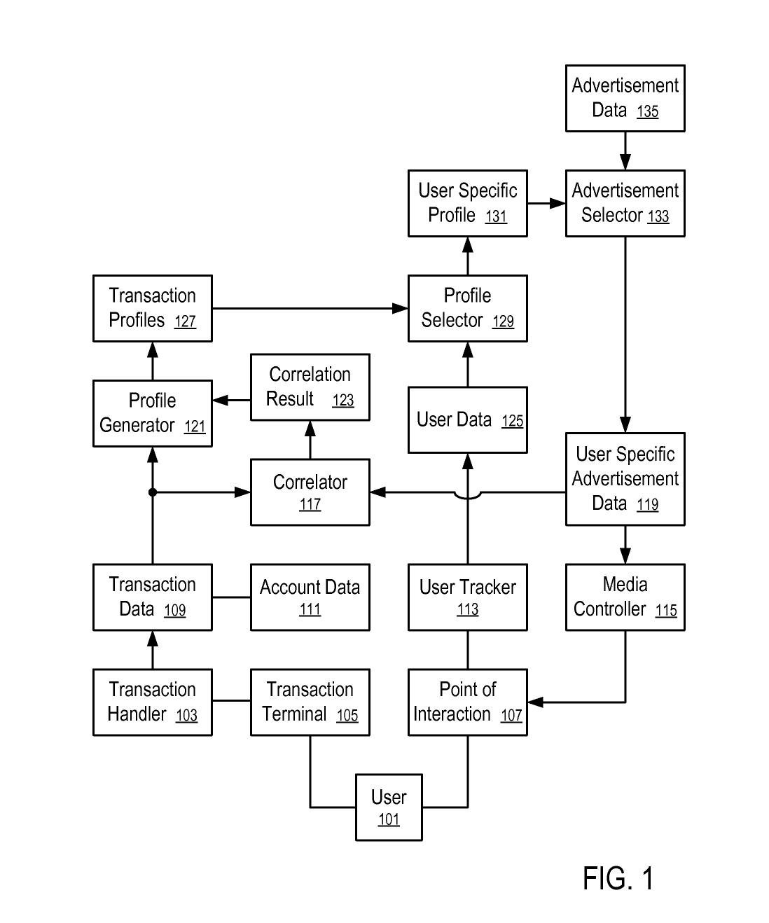

FIG. 1 illustrates a system to provide services based on transaction data according to one embodiment. In FIG. 1, the system includes a transaction terminal (105) to initiate financial transactions for a user (101), a transaction handler (103) to generate transaction data (109) from processing the financial transactions of the user (101) (and the financial transactions of other users), a profile generator (121) to generate transaction profiles (127) based on the transaction data (109) to provide information/intelligence about user preferences and spending patterns, a point of interaction (107) to provide information and/or offers to the user (101), a user tracker (113) to generate user data (125) to identify the user (101) using the point of interaction (107), a profile selector (129) to select a profile (131) specific to the user (101) identified by the user data (125), and an advertisement selector (133) to select, identify, generate, adjust, prioritize and/or personalize advertisements for presentation to the user (101) on the point of interaction (107) via a media controller (115).

In FIG. 1, the system further includes a correlator (117) to correlate user specific advertisement data (119) with transactions resulting from the user specific advertisement data (119). The correlation results (123) can be used by the profile generator (121) to improve the transaction profiles (127).

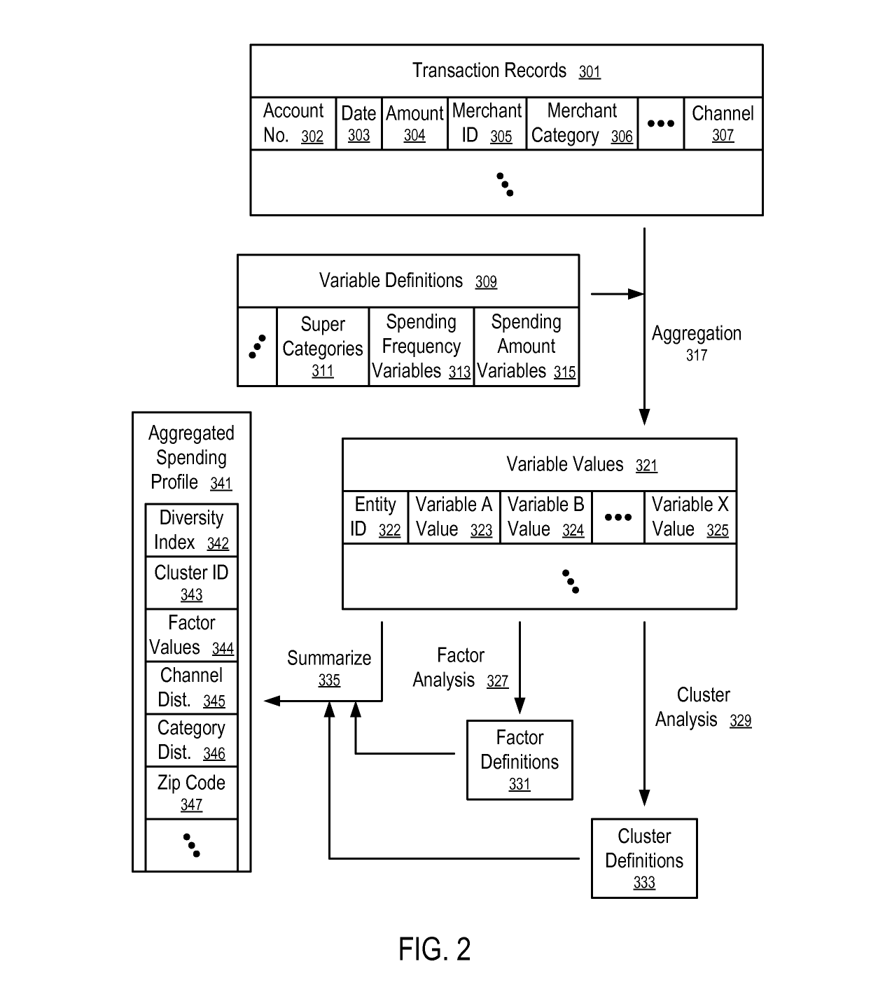

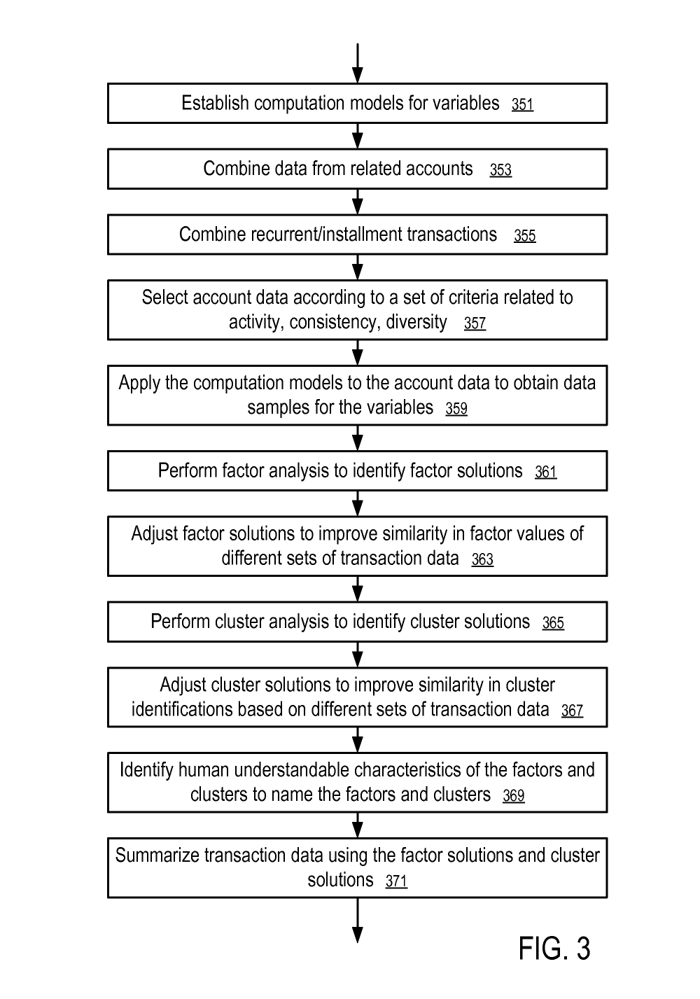

The transaction profiles (127) of one embodiment are generated from the transaction data (109) in a way as illustrated in FIGS. 2 and 3. For example, in FIG. 2, an aggregated spending profile (341) is generated via the factor analysis (327) and cluster analysis (329) to summarize (335) the spending patterns/behaviors reflected in the transaction records (301).

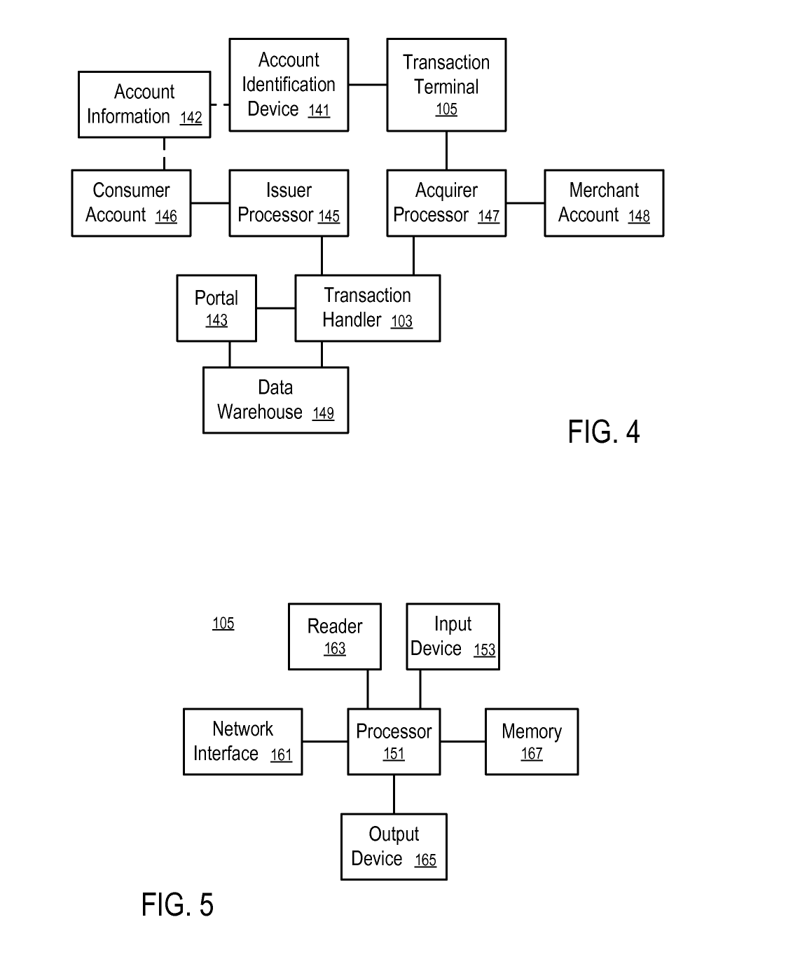

In one embodiment, a data warehouse (149) as illustrated in FIG. 4 is coupled with the transaction handler (103) to store the transaction data (109) and other data, such as account data (111), transaction profiles (127) and correlation results (123). In FIG. 4, a portal (143) is coupled with the data warehouse (149) to provide data or information derived from the transaction data (109), in response to a query request from a third party or as an alert or notification message.

In FIG. 4, the transaction handler (103) is coupled between an issuer processor (145) in control of a consumer account (146) and an acquirer processor (147) in control of a merchant account (148). An account identification device (141) is configured to carry the account information (142) that identifies the consumer account (146) with the issuer processor (145) and provide the account information (142) to the transaction terminal (105) of a merchant to initiate a transaction between the user (101) and the merchant.

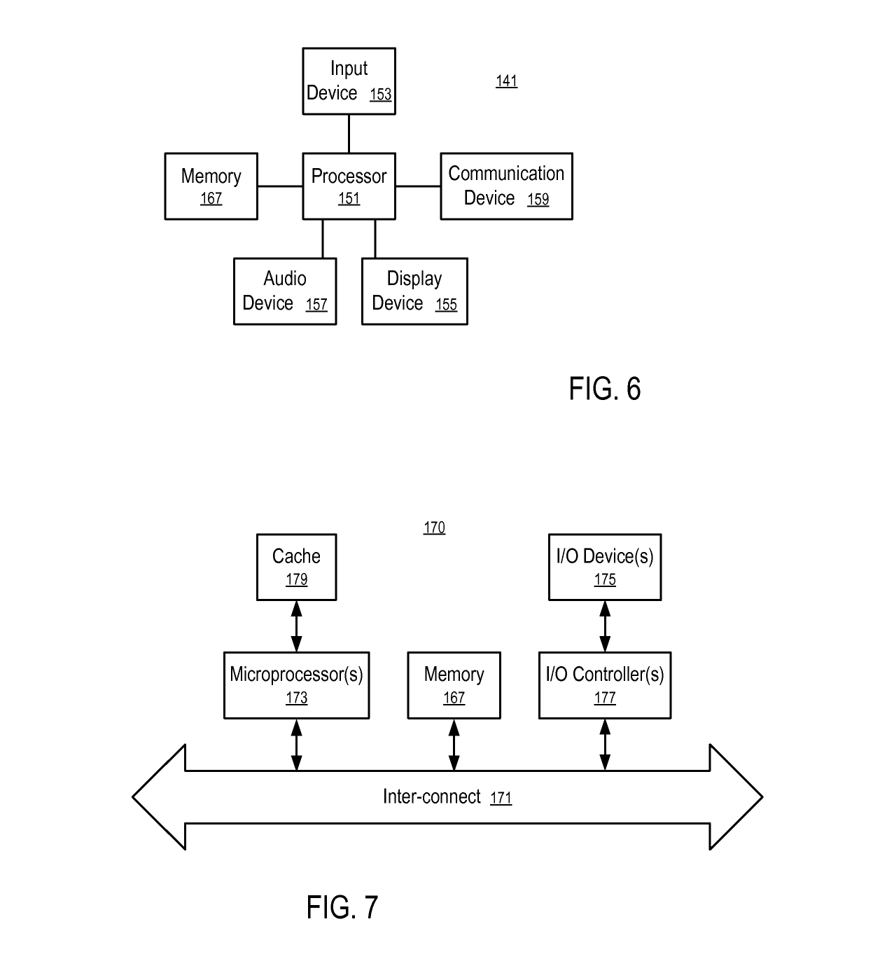

FIGS. 5 and 6 illustrate examples of transaction terminals (105) and account identification devices (141). FIG. 7 illustrates the structure of a data processing system (170) that can be used to implement, with more or fewer elements, at least some of the components in the system, such as the point of interaction (107), the transaction handler (103), the portal (143), the data warehouse, the account identification device (141), the transaction terminal (105), the user tracker (113), the profile generator (121), the profile selector (129), the advertisement selector (133), the media controller (115), etc. Some embodiments use more or fewer components than those illustrated, such as, in FIGS. 1, 4-7, and other figures, as further discussed in the section entitled “VARIATIONS.”

In one embodiment, the transaction data (109) relates to financial transactions processed by the transaction handler (103); and the account data (111) relates to information about the account holders involved in the transactions. Further data, such as merchant data that relates to the location, business, products and/or services of the merchants that receive payments from account holders for their purchases, can be used in the generation of the transaction profiles (127, 341).

In one embodiment, the financial transactions are made via an account identification device (141), such as financial transaction cards (e.g., credit cards, debit cards, banking cards, etc.); the financial transaction cards may be embodied in various devices, such as plastic cards, chips, radio frequency identification (RFID) devices, mobile phones, personal digital assistants (PDAs), etc.; and the financial transaction cards may be represented by account identifiers (e.g., account numbers or aliases). In one embodiment, the financial transactions are made via directly using the account information (142), without physically presenting the account identification device (141).

Further features, modifications and details are provided in various sections of this description.

### Centralized Data Warehouse

In one embodiment, the transaction handler (103) couples with a centralized data warehouse (149) organized around the transaction data (109). For example, the centralized data warehouse (149) may include, and/or support the determination of, spend band distribution, transaction count and amount, merchant categories, merchant by state, cardholder segmentation by velocity scores, and spending within merchant target, competitive set and cross-section.

In one embodiment, the centralized data warehouse (149) provides centralized management but allows decentralized execution. For example, a third party strategic marketing analyst, statistician, marketer, promoter, business leader, etc., may access the centralized data warehouse (149) to analyze customer and shopper data, to provide follow-up analyses of customer contributions, to develop propensity models for increased conversion of marketing campaigns, to develop segmentation models for marketing, etc. The centralized data warehouse (149) can be used to manage advertisement campaigns and analyze response profitability.

In one embodiment, the centralized data warehouse (149) includes merchant data (e.g., data about sellers), customer/business data (e.g., data about buyers), and transaction records (301) between sellers and buyers over time. The centralized data warehouse (149) can be used to support corporate sales forecasting, fraud analysis reporting, sales/customer relationship management (CRM) business intelligence, credit risk prediction and analysis, advanced authorization reporting, merchant benchmarking, business intelligence for small business, rewards, etc.

In one embodiment, the transaction data (109) is combined with external data, such as surveys, benchmarks, search engine statistics, demographics, competition information, emails, etc., to flag key events and data values, to set customer, merchant, data or event triggers, and to drive new transactions and new customer contacts.

### Transaction Profile

In FIG. 1, the profile generator (121) generates transaction profiles (127) based on the transaction data (109), the account data (111), and/or other data, such as non-transactional data, wish lists, merchant provided information, address information, information from social network websites, information from credit bureaus, information from search engines, and other examples discussed in U.S. patent application Ser. No. 12/614,603, filed Nov. 9, 2009, assigned U.S. Pat. App. Pub. No. 2011/0054981, and entitled “Analyzing Local Non-Transactional Data with Transactional Data in Predictive Models,” the disclosure of which is hereby incorporated herein by reference.

In one embodiment, the transaction profiles (127) provide intelligence information on the behavior, pattern, preference, propensity, tendency, frequency, trend, and budget of the user (101) in making purchases. In one embodiment, the transaction profiles (127) include information about what the user (101) owns, such as points, miles, or other rewards currency, available credit, and received offers, such as coupons loaded into the accounts of the user (101). In one embodiment, the transaction profiles (127) include information based on past offer/coupon redemption patterns. In one embodiment, the transaction profiles (127) include information on shopping patterns in retail stores as well as online, including frequency of shopping, amount spent in each shopping trip, distance of merchant location (retail) from the address of the account holder(s), etc.

In one embodiment, the transaction handler (103) provides at least part of the intelligence for the prioritization, generation, selection, customization and/or adjustment of the advertisement for delivery within a transaction process involving the transaction handler (103). For example, the advertisement may be presented to a customer in response to the customer making a payment via the transaction handler (103).

Some of the transaction profiles (127) are specific to the user (101), or to an account of the user (101), or to a group of users of which the user (101) is a member, such as a household, family, company, neighborhood, city, or group identified by certain characteristics related to online activities, offline purchase activities, merchant propensity, etc.

The profile generator (121) may generate and update the transaction profiles (127) in batch mode periodically, or generates the transaction profiles (127) in real time, or just in time, in response to a request received in the portal (143) for such profiles.

The transaction profiles (127) of one embodiment include the values for a set of parameters. Computing the values of the parameters may involve counting transactions that meet one or more criteria, and/or building a statistically-based model in which one or more calculated values or transformed values are put into a statistical algorithm that weights each value to optimize its collective predictiveness for various predetermined purposes.

Further details and examples about the transaction profiles (127) in one embodiment are provided in the section entitled “AGGREGATED SPENDING PROFILE.”

### Non-Transactional Data

In one embodiment, the transaction data (109) is analyzed in connection with non-transactional data to generate transaction profiles (127) and/or to make predictive models.

In one embodiment, transactions are correlated with non-transactional events, such as news, conferences, shows, announcements, market changes, natural disasters, etc. to establish cause and effect relations to predict future transactions or spending patterns. For example, non-transactional data may include the geographic location of a news event, the date of an event from an events calendar, the name of a performer for an upcoming concert, etc. The non-transactional data can be obtained from various sources, such as newspapers, websites, blogs, social networking sites, etc.

When the cause and effect relationships between the transactions and non-transactional events are known (e.g., based on prior research results, domain knowledge, expertise), the relationships can be used in predictive models to predict future transactions or spending patterns, based on events that occurred recently or are happening in real time.

In one embodiment, the non-transactional data relates to events that happened in a geographical area local to the user (101) that performed the respective transactions. In one embodiment, a geographical area is local to the user (101) when the distance from the user (101) to locations in the geographical area is within a convenient range for daily or regular travel, such as 20, 50 or 100 miles from an address of the user (101), or within the same city or zip code area of an address of the user (101). Examples of analyses of local non-transactional data in connection with transaction data (109) in one embodiment are provided in U.S. patent application Ser. No. 12/614,603, filed Nov. 9, 2009, assigned U.S. Pat. App. Pub. No. 2011/0054981, and entitled “Analyzing Local Non-Transactional Data with Transactional Data in Predictive Models,” the disclosure of which is hereby incorporated herein by reference.

In one embodiment, the non-transactional data is not limited to local non-transactional data. For example, national non-transactional data can also be used.

In one embodiment, the transaction records (301) are analyzed in frequency domain to identify periodic features in spending events. The periodic features in the past transaction records (301) can be used to predict the probability of a time window in which a similar transaction would occur. For example, the analysis of the transaction data (109) can be used to predict when a next transaction having the periodic feature would occur, with which merchant, the probability of a repeated transaction with a certain amount, the probability of exception, the opportunity to provide an advertisement or offer such as a coupon, etc. In one embodiment, the periodic features are detected through counting the number of occurrences of pairs of transactions that occurred within a set of predetermined time intervals and separating the transaction pairs based on the time intervals. Some examples and techniques for the prediction of future transactions based on the detection of periodic features in one embodiment are provided in U.S. patent application Ser. No. 12/773,770, filed May 4, 2010, assigned U.S. Pat. App. Pub. No. 2010/0280882, and entitled “Frequency-Based Transaction Prediction and Processing,” the disclosure of which is hereby incorporated herein by reference.

Techniques and details of predictive modeling in one embodiment are provided in U.S. Pat. Nos. 6,119,103, 6,018,723, 6,658,393, 6,598,030, and 7,227,950, the disclosures of which are hereby incorporated herein by reference.

In one embodiment, offers are based on the point-of-service to offeree distance to allow the user (101) to obtain in-person services. In one embodiment, the offers are selected based on transaction history and shopping patterns in the transaction data (109) and/or the distance between the user (101) and the merchant. In one embodiment, offers are provided in response to a request from the user (101), or in response to a detection of the location of the user (101). Examples and details of at least one embodiment are provided in U.S. patent application Ser. No. 11/767,218, filed Jun. 22, 2007, assigned U.S. Pat. App. Pub. No. 2008/0319843, and entitled “Supply of Requested Offer Based on Point-of Service to Offeree Distance,” U.S. patent application Ser. No. 11/755,575, filed May 30, 2007, assigned U.S. Pat. App. Pub. No. 2008/0300973, and entitled “Supply of Requested Offer Based on Offeree Transaction History,” U.S. patent application Ser. No. 11/855,042, filed Sep. 13, 2007, assigned U.S. Pat. App. Pub. No. 2009/0076896, and entitled “Merchant Supplied Offer to a Consumer within a Predetermined Distance,” U.S. patent application Ser. No. 11/855,069, filed Sep. 13, 2007, assigned U.S. Pat. App. Pub. No. 2009/0076925, and entitled “Offeree Requested Offer Based on Point-of Service to Offeree Distance,” and U.S. patent application Ser. No. 12/428,302, filed Apr. 22, 2009, assigned U.S. Pat. App. Pub. No. 2010/0274627, and entitled “Receiving an Announcement Triggered by Location Data,” the disclosures of which applications are hereby incorporated herein by reference.

### Targeting Advertisement

In FIG. 1, an advertisement selector (133) prioritizes, generates, selects, adjusts, and/or customizes the available advertisement data (135) to provide user specific advertisement data (119) based at least in part on the user specific profile (131). The advertisement selector (133) uses the user specific profile (131) as a filter and/or a set of criteria to generate, identify, select and/or prioritize advertisement data for the user (101). A media controller (115) delivers the user specific advertisement data (119) to the point of interaction (107) for presentation to the user (101) as the targeted and/or personalized advertisement.

In one embodiment, the user data (125) includes the characterization of the context at the point of interaction (107). Thus, the use of the user specific profile (131), selected using the user data (125), includes the consideration of the context at the point of interaction (107) in selecting the user specific advertisement data (119).

In one embodiment, in selecting the user specific advertisement data (119), the advertisement selector (133) uses not only the user specific profile (131), but also information regarding the context at the point of interaction (107). For example, in one embodiment, the user data (125) includes information regarding the context at the point of interaction (107); and the advertisement selector (133) explicitly uses the context information in the generation or selection of the user specific advertisement data (119).

In one embodiment, the advertisement selector (133) may query for specific information regarding the user (101) before providing the user specific advertisement data (119). The queries may be communicated to the operator of the transaction handler (103) and, in particular, to the transaction handler (103) or the profile generator (121). For example, the queries from the advertisement selector (133) may be transmitted and received in accordance with an application programming interface or other query interface of the transaction handler (103), the profile generator (121) or the portal (143) of the transaction handler (103).

In one embodiment, the queries communicated from the advertisement selector (133) may request intelligence information regarding the user (101) at any level of specificity (e.g., segment level, individual level). For example, the queries may include a request for a certain field or type of information in a cardholder's aggregate spending profile (341). As another example, the queries may include a request for the spending level of the user (101) in a certain merchant category over a prior time period (e.g., six months).

In one embodiment, the advertisement selector (133) is operated by an entity that is separate from the entity that operates the transaction handler (103). For example, the advertisement selector (133) may be operated by a search engine, a publisher, an advertiser, an ad network, or an online merchant. The user specific profile (131) is provided to the advertisement selector (133) to assist the customization of the user specific advertisement data (119).

In one embodiment, advertising is targeted based on shopping patterns in a merchant category (e.g., as represented by a Merchant Category Code (MCC)) that has high correlation of spending propensity with other merchant categories (e.g., other MCCs). For example, in the context of a first MCC for a targeted audience, a profile identifying second MCCs that have high correlation of spending propensity with the first MCC can be used to select advertisements for the targeted audience.

In one embodiment, the aggregated spending profile (341) is used to provide intelligence information about the spending patterns, preferences, and/or trends of the user (101). For example, a predictive model can be established based on the aggregated spending profile (341) to estimate the needs of the user (101). For example, the factor values (344) and/or the cluster ID (343) in the aggregated spending profile (341) can be used to determine the spending preferences of the user (101). For example, the channel distribution (345) in the aggregated spending profile (341) can be used to provide a customized offer targeted for a particular channel, based on the spending patterns of the user (101).

In one embodiment, mobile advertisements, such as offers and coupons, are generated and disseminated based on aspects of prior purchases, such as timing, location, and nature of the purchases, etc. In one embodiment, the size of the benefit of the offer or coupon is based on purchase volume or spending amount of the prior purchase and/or the subsequent purchase that may qualify for the redemption of the offer. Further details and examples of one embodiment are provided in U.S. patent application Ser. No. 11/960,162, filed Dec. 19, 2007, assigned U.S. Pat. App. Pub. No. 2008/0201226, and entitled “Mobile Coupon Method and Portable Consumer Device for Utilizing Same,” the disclosure of which is hereby incorporated herein by reference.

In one embodiment, conditional rewards are provided to the user (101); and the transaction handler (103) monitors the transactions of the user (101) to identify redeemable rewards that have satisfied the respective conditions. In one embodiment, the conditional rewards are selected based on transaction data (109). Further details and examples of one embodiment are provided in U.S. patent application Ser. No. 11/862,487, filed Sep. 27, 2007, assigned U.S. Pat. App. Pub. No. 2008/0082418, and entitled “Consumer Specific Conditional Rewards,” the disclosure of which is hereby incorporated herein by reference. The techniques to detect the satisfied conditions of conditional rewards can also be used to detect the transactions that satisfy the conditions specified to locate the transactions that result from online activities, such as online advertisements, searches, etc., to correlate the transactions with the respective online activities.

Further details about targeted offer delivery in one embodiment are provided in U.S. patent application Ser. No. 12/185,332, filed Aug. 4, 2008, assigned U.S. Pat. App. Pub. No. 2010/0030644, and entitled “Targeted Advertising by Payment Processor History of Cashless Acquired Merchant Transaction on Issued Consumer Account,” and in U.S. patent application Ser. No. 12/849,793, filed Aug. 3, 2010, assigned U.S. Pat. App. Pub. No. 2011/0035280, and entitled “Systems and Methods for Targeted Advertisement Delivery,” the disclosures of which applications are hereby incorporated herein by reference.

### Profile Matching

In FIG. 1, the user tracker (113) obtains and generates context information about the user (101) at the point of interaction (107), including user data (125) that characterizes and/or identifies the user (101). The profile selector (129) selects a user specific profile (131) from the set of transaction profiles (127) generated by the profile generator (121), based on matching the characteristics of the transaction profiles (127) and the characteristics of the user data (125). For example, the user data (125) indicates a set of characteristics of the user (101); and the profile selector (129) selects the user specific profile (131) that is for a particular user or a group of users and that best matches the set of characteristics specified by the user data (125).

In one embodiment, the profile selector (129) receives the transaction profiles (127) in a batch mode. The profile selector (129) selects the user specific profile (131) from the batch of transaction profiles (127) based on the user data (125). Alternatively, the profile generator (121) generates the transaction profiles (127) in real time; and the profile selector (129) uses the user data (125) to query the profile generator (121) to generate the user specific profile (131) in real time, or just in time. The profile generator (121) generates the user specific profile (131) that best matches the user data (125).

In one embodiment, the user tracker (113) identifies the user (101) based on the user activity on the transaction terminal (105) (e.g., having visited a set of websites, currently visiting a type of web pages, search behavior, etc.).

In one embodiment, the user data (125) includes an identifier of the user (101), such as a global unique identifier (GUID), a personal account number (PAN) (e.g., credit card number, debit card number, or other card account number), or other identifiers that uniquely and persistently identify the user (101) within a set of identifiers of the same type. Alternatively, the user data (125) may include other identifiers, such as an Internet Protocol (IP) address of the user (101), a name or user name of the user (101), or a browser cookie ID, which identify the user (101) in a local, temporary, transient and/or anonymous manner. Some of these identifiers of the user (101) may be provided by publishers, advertisers, ad networks, search engines, merchants, or the user tracker (113). In one embodiment, such identifiers are correlated to the user (101) based on the overlapping or proximity of the time period of their usage to establish an identification reference table.

In one embodiment, the identification reference table is used to identify the account information (142) (e.g., account number (302)) based on characteristics of the user (101) captured in the user data (125), such as browser cookie ID, IP addresses, and/or timestamps on the usage of the IP addresses. In one embodiment, the identification reference table is maintained by the operator of the transaction handler (103). Alternatively, the identification reference table is maintained by an entity other than the operator of the transaction handler (103).

In one embodiment, the user tracker (113) determines certain characteristics of the user (101) to describe a type or group of users of which the user (101) is a member. The transaction profile of the group is used as the user specific profile (131). Examples of such characteristics include geographical location or neighborhood, types of online activities, specific online activities, or merchant propensity. In one embodiment, the groups are defined based on aggregate information (e.g., by time of day, or household), or segment (e.g., by cluster, propensity, demographics, cluster IDs, and/or factor values). In one embodiment, the groups are defined in part via one or more social networks. For example, a group may be defined based on social distances to one or more users on a social network website, interactions between users on a social network website, and/or common data in social network profiles of the users in the social network website.

In one embodiment, the user data (125) may match different profiles at a different granularity or resolution (e.g., account, user, family, company, neighborhood, etc.), with different degrees of certainty. The profile selector (129) and/or the profile generator (121) may determine or select the user specific profile (131) with the finest granularity or resolution with acceptable certainty. Thus, the user specific profile (131) is most specific or closely related to the user (101).

In one embodiment, the advertisement selector (133) uses further data in prioritizing, selecting, generating, customizing and adjusting the user specific advertisement data (119). For example, the advertisement selector (133) may use search data in combination with the user specific profile (131) to provide benefits or offers to a user (101) at the point of interaction (107). For example, the user specific profile (131) can be used to personalize the advertisement, such as adjusting the placement of the advertisement relative to other advertisements, adjusting the appearance of the advertisement, etc.

### Browser Cookie

In one embodiment, the user data (125) uses browser cookie information to identify the user (101). The browser cookie information is matched to account information (142) or the account number (302) to identify the user specific profile (131), such as aggregated spending profile (341) to present effective, timely, and relevant marketing information to the user (101), via the preferred communication channel (e.g., mobile communications, web, mail, email, POS, etc.) within a window of time that could influence the spending behavior of the user (101). Based on the transaction data (109), the user specific profile (131) can improve audience targeting for online advertising. Thus, customers will get better advertisements and offers presented to them; and the advertisers will achieve better return-on-investment for their advertisement campaigns.

In one embodiment, the browser cookie that identifies the user (101) in online activities, such as web browsing, online searching, and using social networking applications, can be matched to an identifier of the user (101) in account data (111), such as the account number (302) of a financial payment card of the user (101) or the account information (142) of the account identification device (141) of the user (101). In one embodiment, the identifier of the user (101) can be uniquely identified via matching IP address, timestamp, cookie ID and/or other user data (125) observed by the user tracker (113).

In one embodiment, a look up table is used to map browser cookie information (e.g., IP address, timestamp, cookie ID) to the account data (111) that identifies the user (101) in the transaction handler (103). The look up table may be established via correlating overlapping or common portions of the user data (125) observed by different entities or different user trackers (113).

In one embodiment, the portal (143) is configured to identify the consumer account (146) based on the IP address identified in the user data (125) through mapping the IP address to a street address.

In one embodiment, the portal (143) uses a plurality of methods to identify consumer accounts (146) based on the user data (125). The portal (143) combines the results from the different methods to determine the most likely consumer account (146) for the user data (125).

Details about the identification of consumer account (146) based on user data (125) in one embodiment are provided in U.S. patent application Ser. No. 12/849,798, filed Aug. 3, 2010, assigned U.S. Pat. App. Pub. No. 2011/0093327, and entitled “Systems and Methods to Match Identifiers,” the disclosure of which is hereby incorporated herein by reference.

### Close the Loop

In one embodiment, the correlator (117) is used to “close the loop” for the tracking of consumer behavior across an on-line activity and an “off-line” activity that results at least in part from the on-line activity. In one embodiment, online activities, such as searching, web browsing, social networking, and/or consuming online advertisements, are correlated with respective transactions to generate the correlation result (123) in FIG. 1. The respective transactions may occur offline, in “brick and mortar” retail stores, or online but in a context outside the online activities, such as a credit card purchase that is performed in a way not visible to a search company that facilitates the search activities.

The correlator (117) is configured in one embodiment to identify transactions resulting from searches or online advertisements. For example, in response to a query about the user (101) from the user tracker (113), the correlator (117) identifies an offline transaction performed by the user (101) and sends the correlation result (123) about the offline transaction to the user tracker (113), which allows the user tracker (113) to combine the information about the offline transaction and the online activities to provide significant marketing advantages.

For example, a marketing department could correlate an advertising budget to actual sales. For example, a marketer can use the correlation result (123) to study the effect of certain prioritization strategies, customization schemes, etc. on the impact on the actual sales. For example, the correlation result (123) can be used to adjust or prioritize advertisement placement on a web site, a search engine, a social networking site, an online marketplace, or the like.

In one embodiment, the profile generator (121) uses the correlation result (123) to augment the transaction profiles (127) with data indicating the rate of conversion from searches or advertisements to purchase transactions. In one embodiment, the correlation result (123) is used to generate predictive models to determine what a user (101) is likely to purchase when the user (101) is searching using certain keywords or when the user (101) is presented with an advertisement or offer. In one embodiment, the portal (143) is configured to report the correlation result (123) to a partner, such as a search engine, a publisher, or a merchant, to allow the partner to use the correlation result (123) to measure the effectiveness of advertisements and/or search result customization, to arrange rewards, etc.

In one embodiment, the correlator (117) matches the online activities and the transactions based on matching the user data (125) provided by the user tracker (113) and the records of the transactions, such as transaction data (109) or transaction records (301). In another embodiment, the correlator (117) matches the online activities and the transactions based on the redemption of offers/benefits provided in the user specific advertisement data (119).

In one embodiment, the portal (143) is configured to receive a set of conditions and an identification of the user (101), determine whether there is any transaction of the user (101) that satisfies the set of conditions, and if so, provide indications of the transactions that satisfy the conditions and/or certain details about the transactions, which allows the requester to correlate the transactions with certain user activities, such as searching, web browsing, consuming advertisements, etc.

In one embodiment, the requester may not know the account number (302) of the user (101); and the portal (143) is to map the identifier provided in the request to the account number (302) of the user (101) to provide the requested information. Examples of the identifier being provided in the request to identify the user (101) include an identification of an iFrame of a web page visited by the user (101), a browser cookie ID, an IP address and the day and time corresponding to the use of the IP address, etc.

The information provided by the portal (143) can be used in pre-purchase marketing activities, such as customizing content or offers, prioritizing content or offers, selecting content or offers, etc., based on the spending pattern of the user (101). The content that is customized, prioritized, selected, or recommended may be the search results, blog entries, items for sale, etc.

The information provided by the portal (143) can be used in post-purchase activities. For example, the information can be used to correlate an offline purchase with online activities. For example, the information can be used to determine purchases made in response to media events, such as television programs, advertisements, news announcements, etc.

Details about profile delivery, online activity to offline purchase tracking, techniques to identify the user specific profile (131) based on user data (125) (such as IP addresses), and targeted delivery of advertisement/offer/benefit in some embodiments are provided in U.S. patent application Ser. No. 12/849,789, filed Aug. 3, 2010, assigned U.S. Pat. App. Pub. No. 2011/0035278, and entitled “Systems and Methods for Closing the Loop between Online Activities and Offline Purchases,” the disclosure of which application is incorporated herein by reference.

### Loyalty Program

In one embodiment, the transaction handler (103) uses the account data (111) to store information for third party loyalty programs.

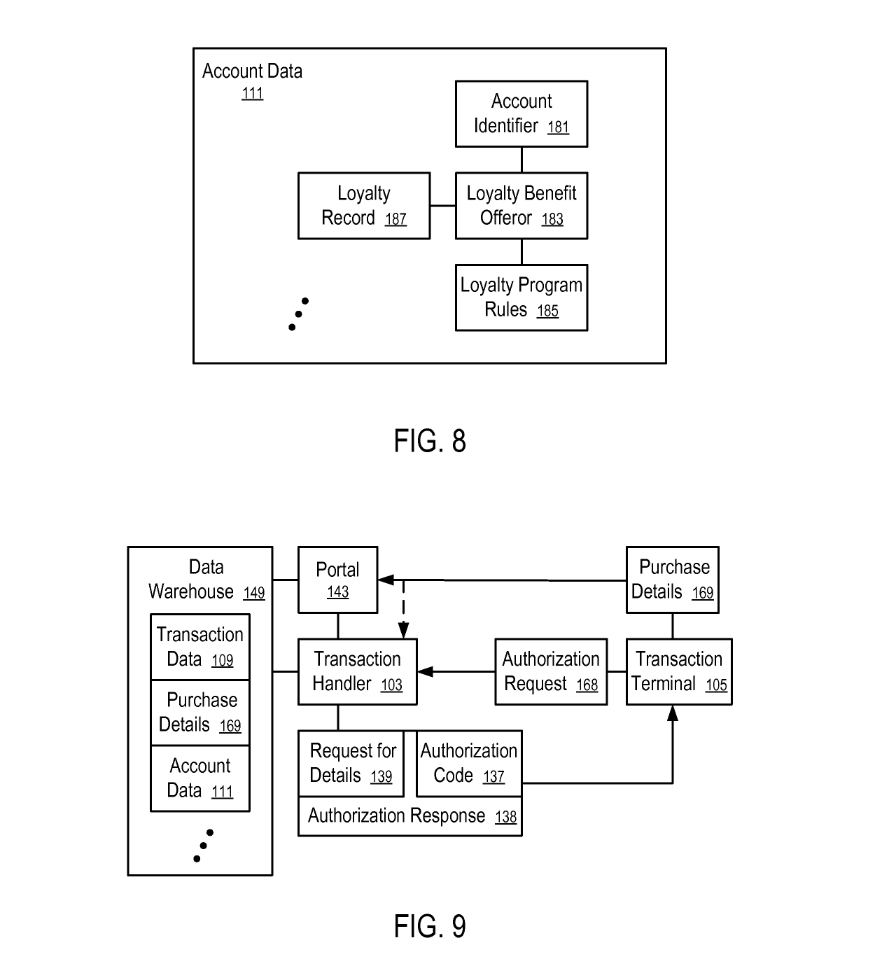

FIG. 8 shows the structure of account data (111) for providing loyalty programs according to one embodiment. In FIG. 8, data related to a third party loyalty program may include an identifier of the loyalty benefit offeror (183) that is linked to a set of loyalty program rules (185) and loyalty record (187) for the loyalty program activities of the account identifier (181). In one embodiment, at least part of the data related to the third party loyalty program is stored under the account identifier (181) of the user (101), such as the loyalty record (187).

FIG. 8 illustrates the data related to one third party loyalty program of a loyalty benefit offeror (183). In one embodiment, the account identifier (181) may be linked to multiple loyalty benefit offerors (e.g., 183), corresponding to different third party loyalty programs. The third party loyalty program of the loyalty benefit offeror (183) provides the user (101), identified by the account identifier (181), with benefits, such as discounts, rewards, incentives, cash back, gifts, coupons, and/or privileges.

In one embodiment, the association between the account identifier (181) and the loyalty benefit offeror (183) in the account data (111) indicates that the user (101) having the account identifier (181) is a member of the loyalty program. Thus, the user (101) may use the account identifier (181) to access privileges afforded to the members of the loyalty programs, such as rights to access a member only area, facility, store, product or service, discounts extended only to members, or opportunities to participate in certain events, buy certain items, or receive certain services reserved for members.

In one embodiment, it is not necessary to make a purchase to use the privileges. The user (101) may enjoy the privileges based on the status of being a member of the loyalty program. The user (101) may use the account identifier (181) to show the status of being a member of the loyalty program.

For example, the user (101) may provide the account identifier (181) (e.g., the account number of a credit card) to the transaction terminal (105) to initiate an authorization process for a special transaction which is designed to check the member status of the user (101), as if the account identifier (181) were used to initiate an authorization process for a payment transaction. The special transaction is designed to verify the member status of the user (101) via checking whether the account data (111) is associated with the loyalty benefit offeror (183). If the account identifier (181) is associated with the corresponding loyalty benefit offeror (183), the transaction handler (103) provides an approval indication in the authorization process to indicate that the user (101) is a member of the loyalty program. The approval indication can be used as a form of identification to allow the user (101) to access member privileges, such as access to services, products, opportunities, facilities, discounts, permissions, which are reserved for members.

In one embodiment, when the account identifier (181) is used to identify the user (101) as a member to access member privileges, the transaction handler (103) stores information about the access of the corresponding member privilege in loyalty record (187). The profile generator (121) may use the information accumulated in the loyalty record (187) to enhance transaction profiles (127) and provide the user (101) with personalized/targeted advertisements, with or without further offers of benefit (e.g., discounts, incentives, rebates, cash back, rewards, etc.).

In one embodiment, the association of the account identifier (181) and the loyalty benefit offeror (183) also allows the loyalty benefit offeror (183) to access at least a portion of the account data (111) relevant to the loyalty program, such as the loyalty record (187) and certain information about the user (101), such as name, address, and other demographic data.

In one embodiment, the loyalty program allows the user (101) to accumulate benefits according to loyalty program rules (185), such as reward points, cash back, levels of discounts, etc. For example, the user (101) may accumulate reward points for transactions that satisfy the loyalty program rules (185); and the user (101) may use the reward points to redeem cash, gift, discounts, etc. In one embodiment, the loyalty record (187) stores the accumulated benefits; and the transaction handler (103) updates the loyalty record (187) associated with the loyalty benefit offeror (183) and the account identifier (181), when events that satisfy the loyalty program rules occur.

In one embodiment, the accumulated benefits as indicated in the loyalty record (187) can be redeemed when the account identifier (181) is used to perform a payment transaction, when the payment transaction satisfies the loyalty program rules. For example, the user (101) may redeem a number of points to offset or reduce an amount of the purchase price.

In one embodiment, when the user (101) uses the account identifier (181) to make purchases as a member, the merchant may further provide information about the purchases; and the transaction handler (103) can store the information about the purchases as part of the loyalty record (187). The information about the purchases may identify specific items or services purchased by the member. For example, the merchant may provide the transaction handler (103) with purchase details at stock-keeping unit (SKU) level, which are then stored as part of the loyalty record (187). The loyalty benefit offeror (183) may use the purchase details to study the purchase behavior of the user (101); and the profile generator (121) may use the SKU level purchase details to enhance the transaction profiles (127).

In one embodiment, the SKU level purchase details are requested from the merchants or retailers via authorization responses (e.g., as illustrated in FIG. 9), when the account (146) of the user (101) is enrolled in a loyalty program that allows the transaction handler (103) (and/or the issuer processor (145)) to collect the purchase details.

A method to provide loyalty programs of one embodiment includes the use of the transaction handler (103) as part of a computing apparatus. The computing apparatus processes a plurality of payment card transactions. After the computing apparatus receives a request to track transactions for a loyalty program, such as the loyalty program rules (185), the computing apparatus stores and updates loyalty program information in response to transactions occurring in the loyalty program. The computing apparatus provides to a customer (e.g., 101) an offer of a benefit when the customer satisfies a condition defined in the loyalty program, such as the loyalty program rules (185).

Examples of loyalty programs through collaboration between collaborative constituents in a payment processing system, including the transaction handler (103) in one embodiment are provided in U.S. patent application Ser. No. 11/767,202, filed Jun. 22, 2007, assigned U.S. Pat. App. Pub. No. 2008/0059302, and entitled “Loyalty Program Service,” U.S. patent application Ser. No. 11/848,112, filed Aug. 30, 2007, assigned U.S. Pat. App. Pub. No. 2008/0059306, and entitled “Loyalty Program Incentive Determination,” and U.S. patent application Ser. No. 11/848,179, filed Aug. 30, 2007, assigned U.S. Pat. App. Pub. No. 2008/0059307, and entitled “Loyalty Program Parameter Collaboration,” the disclosures of which applications are hereby incorporated herein by reference.

Examples of processing the redemption of accumulated loyalty benefits via the transaction handler (103) in one embodiment are provided in U.S. patent application Ser. No. 11/835,100, filed Aug. 7, 2007, assigned U.S. Pat. App. Pub. No. 2008/0059303, and entitled “Transaction Evaluation for Providing Rewards,” the disclosure of which is hereby incorporated herein by reference.

In one embodiment, the incentive, reward, or benefit provided in the loyalty program is based on the presence of correlated related transactions. For example, in one embodiment, an incentive is provided if a financial payment card is used in a reservation system to make a reservation and the financial payment card is subsequently used to pay for the reserved good or service. Further details and examples of one embodiment are provided in U.S. patent application Ser. No. 11/945,907, filed Nov. 27, 2007, assigned U.S. Pat. App. Pub. No. 2008/0071587, and entitled “Incentive Wireless Communication Reservation,” the disclosure of which is hereby incorporated herein by reference.

In one embodiment, the transaction handler (103) provides centralized loyalty program management, reporting and membership services. In one embodiment, membership data is downloaded from the transaction handler (103) to acceptance point devices, such as the transaction terminal (105). In one embodiment, loyalty transactions are reported from the acceptance point devices to the transaction handler (103); and the data indicating the loyalty points, rewards, benefits, etc. are stored on the account identification device (141). Further details and examples of one embodiment are provided in U.S. patent application Ser. No. 10/401,504, filed Mar. 27, 2003, assigned U.S. Pat. App. Pub. No. 2004/0054581, and entitled “Network Centric Loyalty System,” the disclosure of which is hereby incorporated herein by reference.

In one embodiment, the portal (143) of the transaction handler (103) is used to manage reward or loyalty programs for entities such as issuers, merchants, etc. The cardholders, such as the user (101), are rewarded with offers/benefits from merchants. The portal (143) and/or the transaction handler (103) track the transaction records for the merchants for the reward or loyalty programs. Further details and examples of one embodiment are provided in U.S. patent application Ser. No. 11/688,423, filed Mar. 20, 2007, assigned U.S. Pat. App. Pub. No. 2008/0195473, and entitled “Reward Program Manager,” the disclosure of which is hereby incorporated herein by reference.

In one embodiment, a loyalty program includes multiple entities providing access to detailed transaction data, which allows the flexibility for the customization of the loyalty program. For example, issuers or merchants may sponsor the loyalty program to provide rewards; and the portal (143) and/or the transaction handler (103) stores the loyalty currency in the data warehouse (149). Further details and examples of one embodiment are provided in U.S. patent application Ser. No. 12/177,530, filed Jul. 22, 2008, assigned U.S. Pat. App. Pub. No. 2009/0030793, and entitled “Multi-Vender Multi-Loyalty Currency Program,” the disclosure of which is hereby incorporated herein by reference.

In one embodiment, an incentive program is created on the portal (143) of the transaction handler (103). The portal (143) collects offers from a plurality of merchants and stores the offers in the data warehouse (149). The offers may have associated criteria for their distributions. The portal (143) and/or the transaction handler (103) may recommend offers based on the transaction data (109). In one embodiment, the transaction handler (103) automatically applies the benefits of the offers during the processing of the transactions when the transactions satisfy the conditions associated with the offers. In one embodiment, the transaction handler (103) communicates with transaction terminals (105) to set up, customize, and/or update offers based on market focus, product categories, service categories, targeted consumer demographics, etc. Further details and examples of one embodiment are provided in U.S. patent application Ser. No. 12/413,097, filed Mar. 27, 2009, assigned U.S. Pat. App. Pub. No. 2010/0049620, and entitled “Merchant Device Support of an Integrated Offer Network,” the disclosure of which is hereby incorporated herein by reference.

In one embodiment, the transaction handler (103) is configured to provide offers from merchants to the user (101) via the payment system, making accessing and redeeming the offers convenient for the user (101). The offers may be triggered by and/or tailored to a previous transaction, and may be valid only for a limited period of time starting from the date of the previous transaction. If the transaction handler (103) determines that a subsequent transaction processed by the transaction handler (103) meets the conditions for the redemption of an offer, the transaction handler (103) may credit the consumer account (146) for the redemption of the offer and/or provide a notification message to the user (101). Further details and examples of one embodiment are provided in U.S. patent application Ser. No. 12/566,350, filed Sep. 24, 2009, assigned U.S. Pat. App. Pub. No. 2010/0114686, and entitled “Real-Time Statement Credits and Notifications,” the disclosure of which is hereby incorporated herein by reference.

Details on loyalty programs in one embodiment are provided in U.S. patent application Ser. No. 12/896,632, filed Oct. 1, 2010, assigned U.S. Pat. App. Pub. No. 2011/0087530, and entitled “Systems and Methods to Provide Loyalty Programs,” the disclosure of which is hereby incorporated herein by reference.

### SKU

In one embodiment, merchants generate stock-keeping unit (SKU) or other specific information that identifies the particular goods and services purchased by the user (101) or customer. The SKU information may be provided to the operator of the transaction handler (103) that processed the purchases. The operator of the transaction handler (103) may store the SKU information as part of transaction data (109), and reflect the SKU information for a particular transaction in a transaction profile (127 or 131) associated with the person involved in the transaction.

When a user (101) shops at a traditional retail store or browses a website of an online merchant, an SKU-level profile associated specifically with the user (101) may be provided to select an advertisement appropriately targeted to the user (101) (e.g., via mobile phones, POS terminals, web browsers, etc.). The SKU-level profile for the user (101) may include an identification of the goods and services historically purchased by the user (101). In addition, the SKU-level profile for the user (101) may identify goods and services that the user (101) may purchase in the future. The identification may be based on historical purchases reflected in SKU-level profiles of other individuals or groups that are determined to be similar to the user (101). Accordingly, the return on investment for advertisers and merchants can be greatly improved.

In one embodiment, the user specific profile (131) is an aggregated spending profile (341) that is generated using the SKU-level information. For example, in one embodiment, the factor values (344) correspond to factor definitions (331) that are generated based on aggregating spending in different categories of products and/or services. A typical merchant offers products and/or services in many different categories.

In one embodiment, the SKU level purchase details are requested from the merchants or retailers via authorization responses (e.g., as illustrated in FIG. 9), when the account (146) of the user (101) is enrolled in a program that allows the transaction handler (103) (and/or the issuer processor (145)) to collect the purchase details. Based on the SKU information and perhaps other transaction data, the profile generator (121) may create an SKU-level transaction profile for the user (101). In one embodiment, based on the SKU information associated with the transactions for each person entering into transactions with the operator of the transaction handler (103), the profile generator (121) may create an SKU-level transaction profile for each person.

Details on SKU-level profile in one embodiment are provided in U.S. patent application Ser. No. 12/899,144, filed Oct. 6, 2010, assigned U.S. Pat. App. Pub. No. 2011/0093335, and entitled “Systems and Methods for Advertising Services Based on an SKU-Level Profile,” the disclosure of which is hereby incorporated herein by reference.

### Purchase Details

In one embodiment, the transaction handler (103) is configured to selectively request purchase details via authorization responses. When the transaction handler (103) (and/or the issuer processor (145)) needs purchase details, such as identification of specific items purchased and/or their prices, the authorization responses transmitted from the transaction handler (103) is to include an indicator to request for the purchase details for the transaction that is being authorized. The merchants are to determine whether or not to submit purchase details based on whether or not there is a demand indicated in the authorization responses from the transaction handler (103).

FIG. 9 shows a system to obtain purchase details according to one embodiment. In FIG. 9, when the user (101) uses the consumer account (146) to make a payment for a purchase, the transaction terminal (105) of the merchant or retailer sends an authorization request (168) to the transaction handler (103). In response, an authorization response (138) is transmitted from the transaction handler (103) to the transaction terminal (105) to inform the merchant or retailer of the decision to approve or reject the payment request, as decided by the issuer processor (145) and/or the transaction handler (103). The authorization response (138) typically includes an authorization code (137) to identify the transaction and/or to signal that the transaction is approved.

In one embodiment, when the transaction is approved and there is a need for purchase details (169), the transaction handler (103) (or the issuer processor (145)) is to provide an indicator of the request (139) for purchase details in the authorization response (138). The optional request (139) allows the transaction handler (103) (and/or the issuer processor (145)) to request purchase details (169) from the merchant or retailer on demand. When the request (139) for purchase details is present in the authorization response (138), the transaction terminal (105) is to provide the purchase details (169) associated with the payment transaction to the transaction handler (103) directly or indirectly via the portal (143). When the request (139) is absent from the authorization response (138), the transaction terminal (105) does not have to provide the purchase details (169) for the payment transaction.

In one embodiment, prior to transmitting the authorization response (138), the transaction handler (103) (and/or the issuer processor (145)) determines whether there is a need for transaction details. When there is no need for the purchase details (169) for a payment transaction, the request (139) for purchase details (169) is not provided in the authorization response (138) for the payment transaction. When there is a need for the purchase details (169) for a payment transaction, the request (139) for purchase details is provided in the authorization response (138) for the payment transaction. The merchants or retailers do not have to send detailed purchase data to the transaction handler (103) when the authorization response message does not explicitly request detailed purchase data.

Thus, the transaction handler (103) (or the issuer processor (145)) does not have to require all merchants or retailers to send the detailed purchase data (e.g., SKU level purchase details) for all payment transactions processed by the transaction handler (103) (or the issuer processor (145)).

For example, when the consumer account (146) of the user (103) has collected a manufacturer coupon for a product or service that may be sold by the merchant or retailer operating the transaction terminal (105), the transaction handler (103) is to request the purchase details (169) via the authorization response (138) in one embodiment. If the purchase details (169) show that the conditions for the redemption of the manufacturer coupon are satisfied, the transaction handler (103) is to provide the benefit of the manufacturer coupon to the user (101) via credits to the statement for the consumer account (146). This automation of the fulfillment of manufacturer coupon releases the merchant/retailer from the work and complexities in processing manufacturer offers and improves user experiences. Further, retailers and manufacturers are provided with a new consumer promotion distribution channel through the transaction handler (103), which can target the offers based on the transaction profiles (127) of the user (101) and/or the transaction data (109). In one embodiment, the transaction handler (103) can use the offer for loyalty/reward programs.

In another example, if the user (101) is enrolled in a program to request the transaction handler (103) to track and manage purchase details (169) for the user (103), the transaction handler (103) is to request the transaction details (169) via the authorization response (138).

In one embodiment, a message for the authorization response (138) is configured to include a field to indicate whether purchase details are requested for the transaction.

In one embodiment, the authorization response message includes a field to indicate whether the account (146) of the user (101) is a participant of a coupon redemption network. When the field indicates that the account (146) of the user (101) is a participant of a coupon redemption network, the merchant or retailer is to submit the purchase details (169) for the payment made using the account (146) of the user (101).

In one embodiment, when the request (139) for the purchase details (169) is present in the authorization response (138), the transaction terminal (105) of the merchant or retailer is to store the purchase details (169) with the authorization information provided in the authorization response (138). When the transaction is submitted to the transaction handler (103) for settlement, the purchase details (169) are also submitted with the request for settlement.

In one embodiment, the purchase details (169) are transmitted to the transaction handler (103) via a communication channel separate from the communication channel used for the authorization and/or settlement requests for the transaction. For example, the merchant or the retailer may report the purchase details to the transaction handler (103) via a portal (143) of the transaction handler (103). In one embodiment, the report includes an identification of the transaction (e.g., an authorization code (137) for the payment transaction) and the purchase details (e.g., SKU number, Universal Product Code (UPC)).

In one embodiment, the portal (143) of the transaction handler (103) may further communicate with the merchant or the retailer to reduce the amount of purchase detail data to be transmitted the transaction handler (103). For example, in one embodiment, the transaction handler (103) provides an indication of categories of services or products for which the purchase details (169) are requested; and the merchant or retailer is to report only the items that are in these categories. In one embodiment, the portal (143) of the transaction handler (103) is to ask the merchant or the retailer to indicate whether the purchased items include a set of items required for the redemption of the offers.

In one embodiment, the merchant or retailer is to complete the purchase based upon the indication of approval provided in the authorization response (138). When the indicator (e.g., 139) is present in the authorization response (138), the merchant (e.g. inventory management system or the transaction terminal (105)) is to capture and retain the purchase details (169) in an electronic data file. The purchase details (169) include the identification of the individual items purchased (e.g., SKU and/or UPC), their prices, and/or brief descriptions of the items.

In one embodiment, the merchant or retailer is to send the transaction purchase data file to the transaction handler (103) (or the issuer processor (145)) at the end of the day, or according to some other prearranged schedule. In one embodiment, the data file for purchase details (169) is transmitted together with the request to settle the transaction approved via the authorization response (138). In one embodiment, the data file for purchase details (169) is transmitted separately from the request to settle the transaction approved via the authorization response (138).

Further details and examples of one embodiment of offer fulfillment are provided in U.S. patent application Ser. No. 13/113,710, filed May 23, 2011 and entitled “Systems and Methods for Redemption of Offers,” the disclosure of which is hereby incorporated herein by reference.

### Targeted Advertisement Delivery

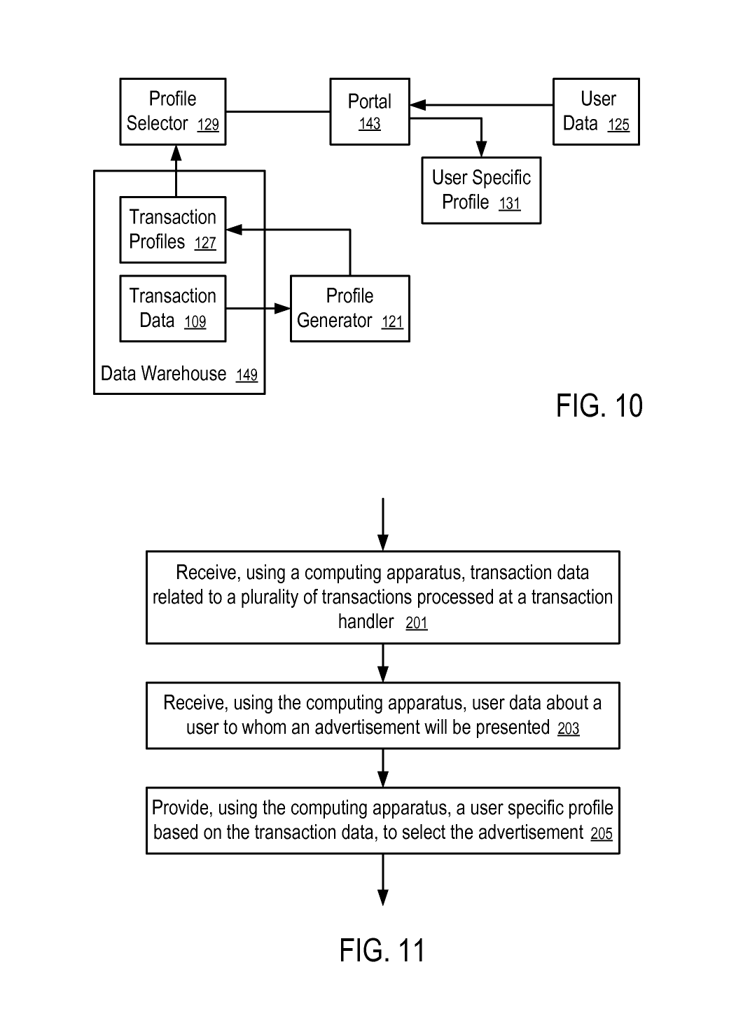

FIG. 10 shows a system to provide profiles to target advertisements according to one embodiment. In FIG. 10, the portal (143) is used to provide a user specific profile (131) in real time in response to a request that uses the user data (125) to identify the user (e.g., 101) of the point of interaction (e.g., 107), on which an advertisement can be presented.

In one embodiment, the profile selector (129) selects the user specific profile (131) from the set of transaction profiles (127), based on matching the characteristics of the users of the transaction profiles (127) and the characteristics of the user data (125). The transaction profiles (127), previously generated by the profile generator (121) using the transaction data (109), are stored in the data warehouse (149).

In one embodiment, the user data (125) indicates a set of characteristics of the user (101); and using the user data (125), the profile selector (129) determines an identity of the user (101) that is uniquely associated with a transaction profile (131). An example of such an identity is the account information (142) identifying the consumer account (146) of the user (101), such as account number (302) in the transaction records (301). In one embodiment, the user data (125) does not include the identity of the user (101); and the profile selector (129) determines the identity of the user (101) based on matching information associated with the identity of the user (101) and information provided in the user data (125), such as via matching IP addresses, street addresses, browser cookie IDs, patterns of online activities, patterns of purchase activities, etc.

In one embodiment, after the identity of the user (101) is determined using the user data (125), the profile generator (121) generates the user specific profile (131) in real time from the transaction data (109) of the user (101). In one embodiment, the user specific profile (131) is calculated after the user data (125) is received; and the user specific profile (131) is provided as a response to the request that provides the user data (125). Thus, the user specific profile (131) is calculated in real time with respect to the request, or just in time to service the request.

In one embodiment, the profile selector (129) selects the user specific profile (131) that is for a particular user or a group of users and that best matches the set of characteristics specified by the user data (125). In one embodiment, the profile generator (121) generates the user specific profile (131) that best matches the user or users identified by the user data (125).

In another embodiment, the portal (143) of the transaction handler (103) is configured to provide the set of transaction profiles (127) in a batch mode. A profile user, such as a search engine, a publisher, or an advertisement agency, is to select the user specific profile (131) from the set of previously received transaction profiles (127).

FIG. 11 shows a method to provide a profile for advertising according to one embodiment. In FIG. 11, a computing apparatus receives (201) transaction data (109) related to a plurality of transactions processed at a transaction handler (103), receives (203) user data (125) about a user (101) to whom an advertisement (e.g., 119) will be presented, and provides (205) a user specific profile (131) based on the transaction data (109) to select, generate, prioritize, customize, or adjust the advertisement (e.g., 119).

In one embodiment, the computing apparatus includes at least one of: a portal (143), a profile selector (129) and a profile generator (121). The computing apparatus is to deliver the user specific profile (131) to a third party in real time in response to a request that identifies the user (101) using the user data (125).

In one embodiment, the computing apparatus is to receive a request for a profile (e.g., 131 or 341) to customize information for presentation to a user (101) identified in the request and, responsive to the request identifying the user (101), provide the profile (e.g., 131 or 341) that is generated based on the transaction data (e.g., 109 or 301) of the user (101). In one embodiment, the information includes an advertisement (e.g., 119) identified, selected, prioritized, adjusted, customized, or generated based on the profile (e.g., 131 or 341). In one embodiment, the advertisement includes at least an offer, such as a discount, incentive, reward, coupon, gift, cash back, benefit, product, or service. In one embodiment, the computing apparatus is to generate the information customized according to the profile (e.g., 131 or 341) and/or present the information to the user (101); alternatively, a third party, such as a search engine, publisher, advertiser, advertisement (ad) network, or online merchant, is to customize the information according to the profile (e.g., 131 or 341) and/or present the information to the user (101). In one embodiment, the adjustment of an advertisement or information includes adjusting the order of the advertisement or information relative to other advertisements or information, adjusting the placement location of the advertisement or information, adjusting the presentation format of the advertisement or information, and/or adjusting an offer presented in the advertisement or information. Details about targeting advertisement in one embodiment are provided in the section entitled “TARGETING ADVERTISEMENT.”

In one embodiment, the transaction data (e.g., 109 or 301) is related to a plurality of transactions processed at a transaction handler (103). Each of the transactions is processed to make a payment from an issuer to an acquirer via the transaction handler (103) in response to an account identifier, as issued by the issuer to the user, being submitted by a merchant to the acquirer. The issuer is to make the payment on behalf of the user (101), and the acquirer is to receive the payment on behalf of the merchant. Details about the transaction handler (103) and the portal (143) in one embodiment are provided in the section entitled “TRANSACTION DATA BASED PORTAL.”

In one embodiment, the profile (e.g., 131 or 341) summarizes the transaction data (e.g., 109 or 301) of the user (101) using a plurality of values (e.g., 344 or 346) representing aggregated spending in various areas. In one embodiment, the values are computed for factors identified from a factor analysis (327) of a plurality of variables (e.g., 313 and 315). In one embodiment, the factor analysis (327) is based on transaction data (e.g., 109 or 301) associated with a plurality of users. In one embodiment, the variables (e.g., 313 and 315) aggregate the transactions based on merchant categories (e.g., 306). In one embodiment, the variables include spending frequency variables (e.g., 313) and spending amount variables (e.g., 315). In one embodiment, transactions processed by the transaction handler (103) are classified in a plurality of merchant categories (e.g., 306); and the plurality of values (e.g., 344 or 346) are fewer than the plurality of merchant categories (e.g., 306) to summarize aggregated spending in the plurality of merchant categories (e.g., 306). In one embodiment, each of the plurality of values (e.g., 344 or 346) indicates a level of aggregated spending of the user. In one embodiment, the computing apparatus is to generate the profile (e.g., 131 or 341) using the transaction data (e.g., 109 or 301) of the user (101) based on cluster definitions (333) and factor definitions (331), where the cluster definitions (333) and factor definitions (331) are generated based on transaction data of a plurality of users, which may or may not include the user (101) represented by the profile (e.g., 131 or 341). Details about the profile (e.g., 133 or 341) in one embodiment are provided in the section entitled “TRANSACTION PROFILE” and the section entitled “AGGREGATED SPENDING PROFILE.”

In one embodiment, the profile (e.g., 131 or 341) is calculated prior to the reception of the request in the computing apparatus; and the computing apparatus is to select the profile (e.g., 131 or 341) from a plurality of profiles (127) based on the request identifying the user (101).

In one embodiment, the computing apparatus is to identify the transaction data (e.g., 109 or 301) of the user (101) based on the request identifying the user (101) and calculate the profile (e.g., 131 or 341) based on the transaction data (e.g., 109 or 301) of the user (101) in response to the request.

In one embodiment, the user (101) is identified in the request received in the computing apparatus via an IP address, such as an IP address of the point of interaction (107); and the computing apparatus is to identify the account identifier of the user (101), such as account number (302) or account information (142), based on the IP address. For example, in one embodiment, the computing apparatus is to store account data (111) including a street address of the user (101), map the IP address to a street address of a computing device (e.g., 107) of the user (101), and identify the account identifier (e.g., 302 or 142) of the user (101) based on matching the street address of the computing device and the street address of the user (101) stored in the account data (111).

In one embodiment, the user (101) is identified in the request via an identifier of a browser cookie associated with the user (101). For example, a look up table is used to match the identifier of the browser cookie to the account identifier (e.g., 302 or 142) in one embodiment.

Details about identifying the user in one embodiment are provided in the section entitled “PROFILE MATCHING” and “BROWSER COOKIE.”

One embodiment provides a system that includes a transaction handler (103) to process transactions. Each of the transactions is processed to make a payment from an issuer to an acquirer via the transaction handler (103) in response to an account identifier of a customer, as issued by the issuer, being submitted by a merchant to the acquirer. The issuer is to make the payment on behalf of the customer, and the acquirer is to receive the payment on behalf of the merchant. The system further includes a data warehouse (149) to store transaction data (109) recording the transactions processed at the transaction handler (103), a profile generator (121) to generate a profile (e.g., 131 or 341) of a user (101) based on the transaction data, and a portal (143) to receive a request identifying the user (101) and to provide the profile (e.g., 131 or 341) in response to the request to facilitate customization of information to be presented to the user (101). In one embodiment, the profile includes a plurality of values (e.g., 344 or 346) representing aggregated spending of the user (101) in various areas to summarize the transactions of the user (101).

In one embodiment, the system further includes a profile selector (129) to select the profile (e.g., 131 or 341) from a plurality of profiles (127) generated by the profile generator (121) based on the request identifying the user (101). The profile generator (121) generates the plurality of profiles (127) and stores the plurality of profiles (127) in the data warehouse (149).

In one embodiment, the system further includes an advertisement selector (133) to generate, select, adjust, prioritize, or customize an advertisement in the information according to the profile (e.g., 131 or 341).

### Search

A computing apparatus is configured to: receive a search term from a user; identify a region within which a residence location of the user is located; obtain a spending profile generated based on aggregating transaction data of users residing in the region; and customize a search result based on the spending profile.

For examples, spending of users residing in different regions (e.g., identified via zip+4 postal codes) can be aggregated within respective regions, and normalized and/or ranked across the regions to generate spending preference indicators (e.g., as discussed in the sections entitled “AGGREGATED SPENDING PROFILE” and “AGGREGATED REGION PROFILE”). Further, the average distances between the residence locations of users residing within different regions and merchant locations at which the users make transactions using payment accounts are determined for the respective regions. The spending indicators and the average distances are used to select, prioritize and/or customize search results to reflect the spending preferences of users based on the residence regions of the users.

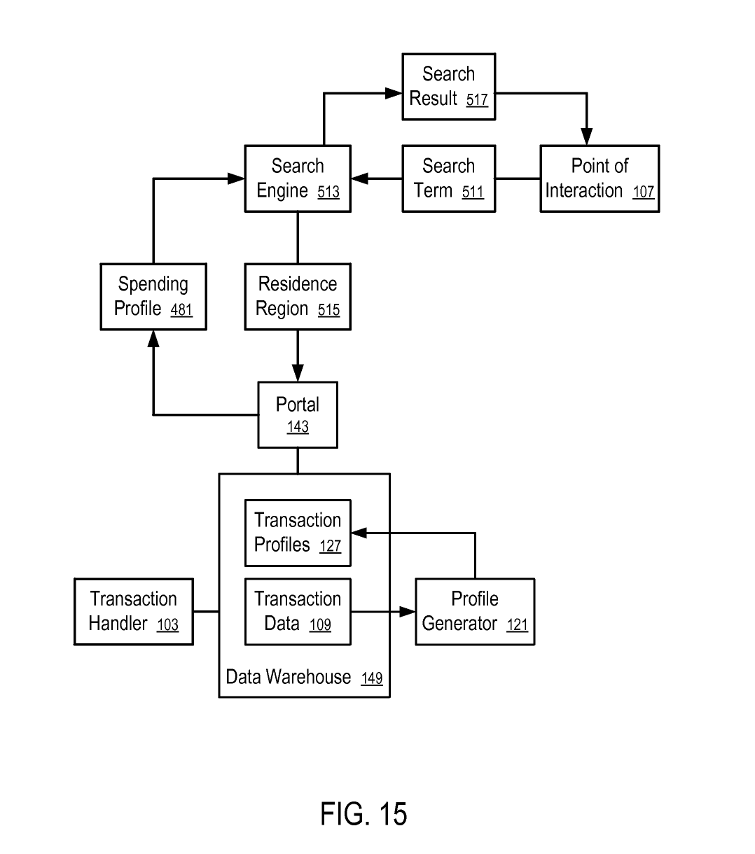

FIG. 15 shows a system to enhance search via transaction data according to one embodiment. In FIG. 15, a search engine (513) is configured to receive a search term (511) from a point of interaction (107) for a search submitted from a user.

In one embodiment, the search engine (513) is configured to identify the residence region (515) in which the residence location (e.g., home address) of the user is located. For example, the search engine (513) may register a user (101) in a program to provide enhanced search results for the user (101). During the registration process, the user (101) may provide the zip+4 code of the home address of the user (101) to indicate the residence region (515) of the user. Alternatively, the search engine (513) may identify the residence region (515) via other indicators, such as the internet protocol (IP) address of the point of interaction (107) of the user (101). For example, when the point of interaction (107) is a mobile device, the home location of the mobile device can be determined from the pattern of locations reported by the mobile device.

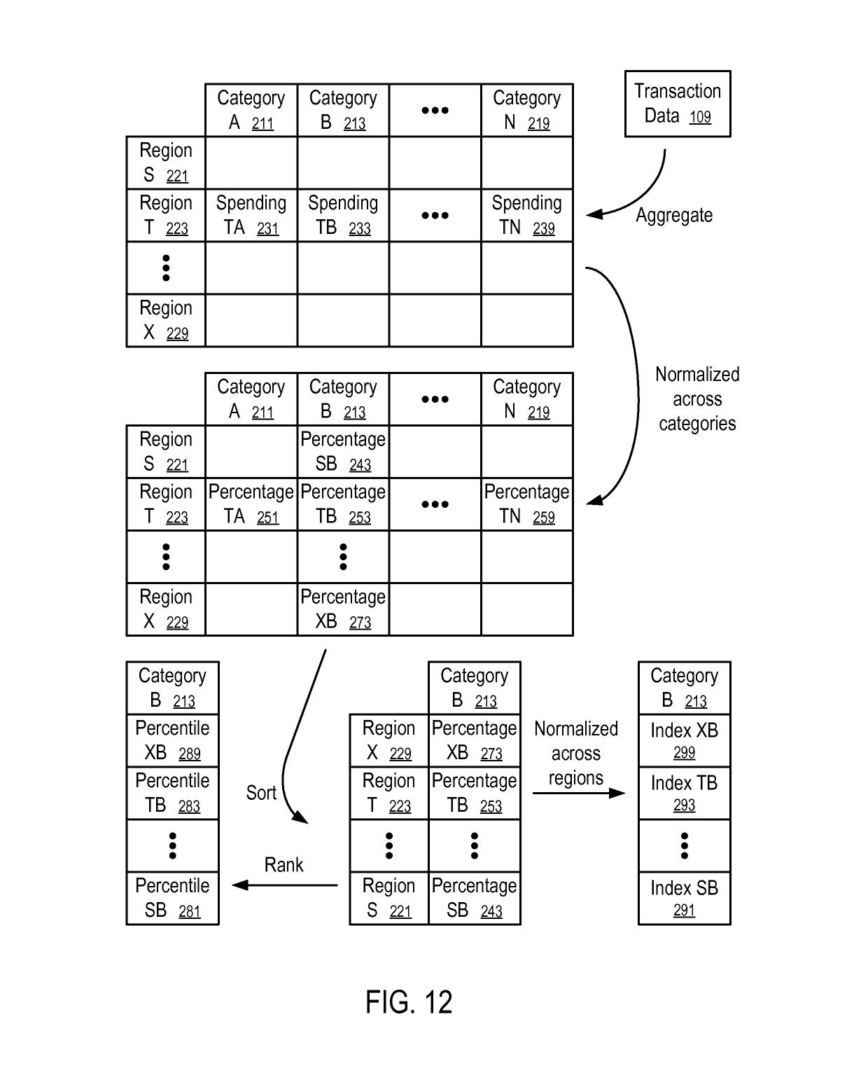

In FIG. 15, the search engine (513) is configured to communicate with a portal (143) coupled with the data warehouse (149). A transaction handler (103) is coupled with the data warehouse (149) to store transaction data (109) recording the transactions processed by the transaction handler (103) (e.g., processed in a way as illustrated in FIG. 4). A profile generator (121) is configured to generate transaction profiles (127) from the transaction data (109) in ways as illustrated in FIG. 2 or 12.

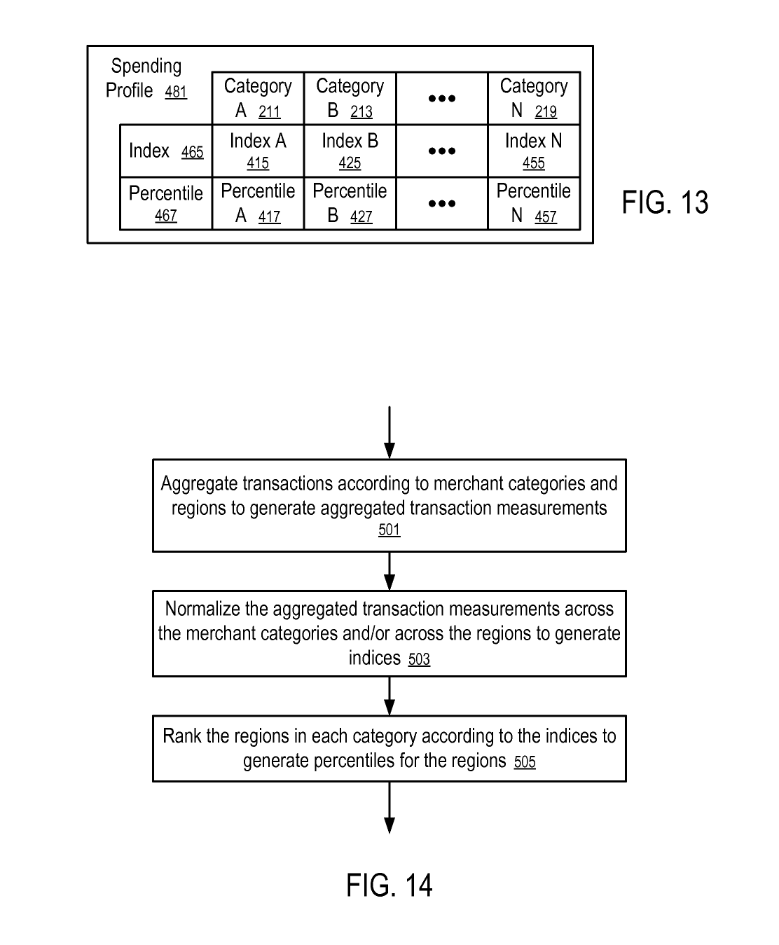

In FIG. 15, after the search engine (513) identifies the residence region (515) to the portal (143), a spending profile (481) (e.g., illustrated in FIG. 13) for the residence region (515) is generated and/or provided to the search engine (513).

In one embodiment, the spending profile (481) includes spending indicators generated based on total spend online and offline. Since the spending profile (481) is generated based on the transaction data, the spending profile (481) is based on the actual transaction history.

In one embodiment, the spending profile (481) segments users based on spending areas, such as entertainment, retail, travel, home, etc. The primary spending categories can be further enhanced with detailed spending classifications, such as: home decorators, home improvers, techies for home spending category; luxury apparel, jewelry sporting for retail category; foodies, fast food mavens, coffee fixes for entertainment category; and frequent travelers, budget travelers, luxury travelers for travel category. The spending segmentation information of users residing in different regions and/or their relative ranking can be used to enhance the presentation of search results.

For example, when a search with the term “men's trousers” is from a user in a residence region classified as “Fashionista”, the search engine (513) may rank the results from high-end merchants carrying items a typical user residing in the residence region (515) is likely to purchase higher than low-end merchants carrying similar items a typical user residing in the residence region (515) is less likely to purchase. Thus, the spending characteristics as reflected in the spending profile (481) can be used to customize the search result.

For example, when a search with the term “men's trousers” is from a user in a residence region classified as “Tactile In-Store Clothing Shopper”, the search engine (513) may rank the results from brick and mortar merchants from which a user residing in the residence region (515) is likely to purchase higher than online merchants carrying similar items but less preferred by a typical user residing in the residence region (515). Thus, the spending patterns as reflected in the spending profile (481) can be used to customize the search results.

For example, when the consumers in the residence region (515) on average travel less than 3 miles from their home to eat out, the search result (517) can be optimized to show restaurants that are in the preferred trade of typical consumers in the residence region (515) for dining out. Restaurants outside the consumer preferred trade area may need to entice the consumer with an offer to get them transaction outside their trade area.

In one embodiment, the spending profile (481) includes the indication of average travel distance between the residence locations of the users within the residence region (515) (e.g., as identified by home addresses) and merchant locations of a particular merchant category at which the consumer accounts (e.g., 146) of the users (e.g., 101) are used to make card-present transactions. The average travel distance can be used to filter and/or customize search results related to the particular merchant category.

For example, the preferred trading area of the user (101) residing in the residence region (515) can be determined by extending the boundary of the residence region (515) by a distance according to the average travel distance. Alternatively, the preferred trading area can be determined by identifying a center and extending from the center by a distance according to the average travel distance. The center of the preferred trading area can be determined from a center of the residence region or the current location of the user (e.g., as reported by a mobile device of the user, when the mobile device is used as the point of interaction (107)). When the home location of the user (101) is known, the home location can be used as the center of the preferred trading area.

In one embodiment, the distance beyond the trading area is weighted against other explicit or implicit criteria of the search to determine a ranking score. For example, the amount of incentive, discount, reward and/or benefit provided by the respective merchants can be weighed against the additional travel distance beyond the trading area to determine a ranking score. The search engine (513) may include many factors in the ranking the search result candidates, such as the closeness between the search term (511) and the services or products offered by the merchant candidates in the search result (517), the spending level indicators as provided in the spending profile (481) relative to the premium level of the merchants in services and products provided by the respective merchants, the store types of the merchants (e.g., brick and mortar stores vs. online stores) relative to the actual spending patterns as revealed in the spending profile (481), the store locations of the merchants relative to the preferred tradition area, the amount of incentive, benefit, reward, discount offered, etc.

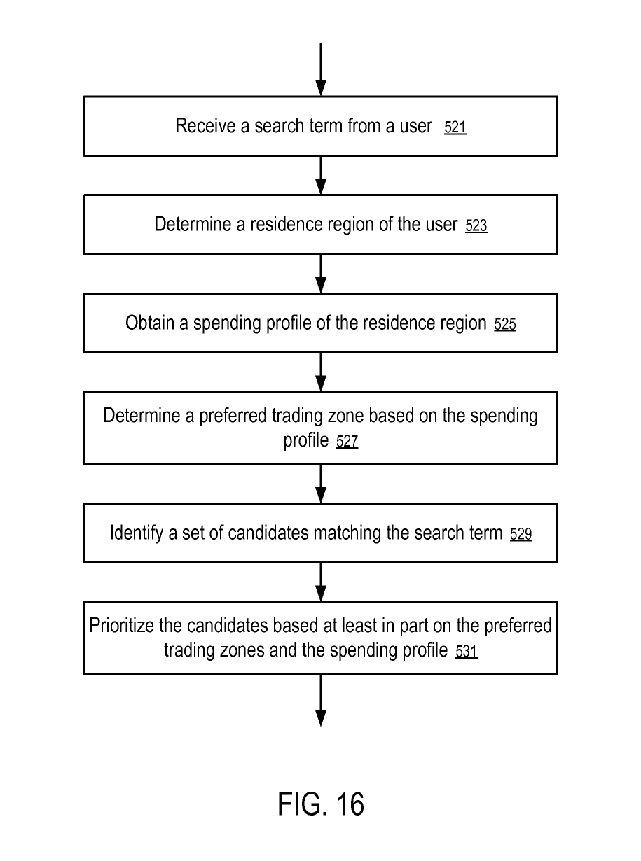

FIG. 16 shows a method to enhance search via transaction data according to one embodiment. A computing apparatus, including a search engine (513) as illustrated in FIG. 15, is configured to: receive (521) a search term (515) from a user(101); determine (523) a residence region (515) of the user (101); obtain (525) a spending profile (481) of the residence region (515); determine (527) a preferred trading zone based on the spending profile (481); identify (529) a set of candidates matching the search term (511); and prioritize (531) the candidates based at least in part on the preferred trading zones and the spending profile (481) to generate a search result (517) responsive to the search term. The search result (517) may or may not include advertisements.

For example, in FIG. 16, the preferred trading zone is determined based on an average travel distance from home addresses of account holders of consumer accounts (e.g., 146) to merchant stores at which the consumer accounts (e.g., 146) are used to make purchases in a particular merchant category, a particular set of merchant categories, or a particular merchant segment. The preferred trading zone is based on the residence of the consumer account, instead of the current location of the consumer. For example, the center of the trading zone may be the center of the residence region, or a home address of the user (101).

In one embodiment, the spending profiles includes spending indexes, percentages, and/or percentiles of aggregated spending by consumers residing in the respective regions and normalized and/or indexed across a set of regions. The spending profiles show preferences over online and offline spending, and rank regions based on historical purchase trends. The spending profile (481) identifies the spending behavior of a typical person residing within a region, without revealing the private information of a particular person or a particular family.

In one embodiment, the search engine (513) and the portal (143) are further configured to communicate with each other to measure the effectiveness of offers presented via the search engine (513). For example, based on the similarity in spending profiles (e.g., 481) for regions (e.g., defined via zip+4 postal codes), a control group of users residing in a first region can be identified for users residing in a second region. Users residing in the first region are not provided with offers delivered via the search engine (513); and users residing in the second region are provided with offers delivered via the search engine (513). The portal (143) is configured to identify transaction trends relevant to the offers and determine the effectiveness of the offers based on the difference in transaction trends following the delivery of the offers to the users residing in the second region.

In one embodiment, the search engine (513) is configured to optimize the ranking of search results based on the effectiveness of prioritization and/or selection of search results. For example, the parameters to prioritize customize, and/or select search results (517) according to the spending profile (481) can be adjusted. Users residing in first region having a spending profile (481) similar to that for a second region can be paired to detect the effect of the parameter adjustment. For example, the users residing in the first region can be provided with the search results without the adjustment; and the users residing in the second region can be provided with the search results with the adjustment. The transaction trends relevant to the search results can be monitored by the portal (143) to determine the effect of the adjustment in the transaction trend over a period of time. Though the detection of the effect of the adjustments, the ranking, customization, prioritization, and/or selection operations can be optimized for improved relevancy.

In one embodiment, the computing apparatus includes at least one microprocessing and a memory storing instructions configured to instruct the microprocessor to perform operations. The computing apparatus includes at least one of: the search engine (513), the portal (143), the transaction handler (103), the data warehouse (149), and the profile generator (121), each of which can be implemented using a data processing system as illustrated in FIG. 7.

Some details about the computing apparatus/system in one embodiment are provided in the sections entitled “SYSTEM,” “CENTRALIZED DATA WAREHOUSE” and “HARDWARE.”

### Variations

Some embodiments use more or fewer components than those illustrated in the figures.

In one embodiment, at least some of the profile generator (121), correlator (117), profile selector (129), and advertisement selector (133) are controlled by the entity that operates the transaction handler (103). In another embodiment, at least some of the profile generator (121), correlator (117), profile selector (129), and advertisement selector (133) are not controlled by the entity that operates the transaction handler (103).

In one embodiment, the products and/or services purchased by the user (101) are also identified by the information transmitted from the merchants or service providers. Thus, the transaction data (109) may include identification of the individual products and/or services, which allows the profile generator (121) to generate transaction profiles (127) with fine granularity or resolution. In one embodiment, the granularity or resolution may be at a level of distinct products and services that can be purchased (e.g., stock-keeping unit (SKU) level), or category or type of products or services, or vendor of products or services, etc.

In one embodiment, the entity operating the transaction handler (103) provides the intelligence information in real time as the request for the intelligence information occurs. In other embodiments, the entity operating the transaction handler (103) may provide the intelligence information in batch mode. The intelligence information can be delivered via online communications (e.g., via an application programming interface (API) on a website, or other information server), or via physical transportation of a computer readable media that stores the data representing the intelligence information.

In one embodiment, the intelligence information is communicated to various entities in the system in a way similar to, and/or in parallel with the information flow in the transaction system to move money. The transaction handler (103) routes the information in the same way it routes the currency involved in the transactions.

In one embodiment, the portal (143) provides a user interface to allow the user (101) to select items offered on different merchant websites and store the selected items in a wish list for comparison, reviewing, purchasing, tracking, etc. The information collected via the wish list can be used to improve the transaction profiles (127) and derive intelligence on the needs of the user (101); and targeted advertisements can be delivered to the user (101) via the wish list user interface provided by the portal (143). Examples of user interface systems to manage wish lists are provided in U.S. patent application Ser. No. 12/683,802, filed Jan. 7, 2010, assigned U.S. Pat. App. Pub. No. 2010/0174623, and entitled “System and Method for Managing Items of Interest Selected from Online Merchants,” the disclosure of which is hereby incorporated herein by reference.

### Aggregated Spending Profile

In one embodiment, the characteristics of transaction patterns of customers are profiled via clusters, factors, and/or categories of purchases. The transaction data (109) may include transaction records (301); and in one embodiment, an aggregated spending profile (341) is generated from the transaction records (301), in a way illustrated in FIG. 2, to summarize the spending behavior reflected in the transaction records (301).

In FIG. 2, each of the transaction records (301) is for a particular transaction processed by the transaction handler (103). Each of the transaction records (301) provides information about the particular transaction, such as the account number (302) of the consumer account (146) used to pay for the purchase, the date (303) (and/or time) of the transaction, the amount (304) of the transaction, the ID (305) of the merchant who receives the payment, the category (306) of the merchant, the channel (307) through which the purchase was made, etc. Examples of channels include online, offline in-store, via phone, etc. In one embodiment, the transaction records (301) may further include a field to identify a type of transaction, such as card-present, card-not-present, etc.

A “card-present” transaction typically involves physically presenting the account identification device (141), such as a financial transaction card, to the merchant (e.g., via swiping a credit card at a POS terminal of a merchant); and a “card-not-present” transaction typically involves presenting the account information (142) of the consumer account (146) to the merchant to identify the consumer account (146) without physically presenting the account identification device (141) to the merchant or the transaction terminal (105).

The transaction records (301) of one embodiment may further include details about the products and/or services involved in the purchase.

When there is voluminous data representing the transaction records (301), the spending patterns reflected in the transaction records (301) can be difficult to recognize by an ordinary person.

In FIG. 2, the voluminous transaction records (301) are summarized (335) into aggregated spending profiles (e.g., 341) to concisely present the statistical spending characteristics reflected in the transaction records (301). The aggregated spending profile (341) uses values derived from statistical analysis to present the statistical characteristics of transaction records (301) of an entity in a way easy to understand by an ordinary person.

In FIG. 2, the transaction records (301) are summarized (335) via factor analysis (327) to condense the variables (e.g., 313, 315) and via cluster analysis (329) to segregate entities by spending patterns.

In FIG. 2, a set of variables (e.g., 311, 313, 315) are defined based on the parameters recorded in the transaction records (301). The variables (e.g., 311, 313, and 315) are defined in a way to have meanings easily understood by an ordinary person. For example, variables (311) measure the aggregated spending in super categories; variables (313) measure the spending frequencies in various areas; and variables (315) measure the spending amounts in various areas. In one embodiment, each of the areas is identified by a merchant category (306) (e.g., as represented by a merchant category code (MCC), a North American Industry Classification System (NAILS) code, or a similarly standardized category code). In other embodiments, an area may be identified by a product category, a SKU number, etc.

Examples of the spending frequency variables (313) and spending amount variables (315) defined for various merchant categories (e.g., 306) in one embodiment are provided in U.S. patent application Ser. No. 12/537,566, filed Aug. 7, 2009, assigned U.S. Pat. App. Pub. No. 2010/0306029, and entitled “Cardholder Clusters,” and in U.S. patent application Ser. No. 12/777,173, filed May 10, 2010, assigned U.S. Pat. App. Pub. No. 2010/0306032, and entitled “Systems and Methods to Summarize Transaction Data,” the disclosures of which applications are hereby incorporated herein by reference.

In FIG. 2, the aggregation (317) includes the application of the definitions (309) for these variables (e.g., 311, 313, and 315) to the transaction records (301) to generate the variable values (321). The transaction records (301) are aggregated to generate aggregated measurements (e.g., variable values (321)) that are not specific to a particular transaction, such as frequencies of purchases made with different merchants or different groups of merchants, the amounts spent with different merchants or different groups of merchants, and the number of unique purchases across different merchants or different groups of merchants, etc. The aggregation (317) can be performed for a particular time period and for entities at various levels.

The transaction records (301) can be aggregated according to a buying entity, or a selling entity. For example, the aggregation (317) can be performed at account level, person level, family level, company level, neighborhood level, city level, region level, etc. to analyze the spending patterns across various areas (e.g., sellers, products or services) for the respective aggregated buying entity. For example, the transaction records (301) for a particular merchant having transactions with multiple accounts can be aggregated for a merchant level analysis. For example, the transaction records (301) for a particular merchant group can be aggregated for a merchant group level analysis. The aggregation (317) can be formed separately for different types of transactions, such as transactions made online, offline, via phone, and/or “card-present” transactions vs. “card-not-present” transactions, which can be used to identify the spending pattern differences among different types of transactions.

In FIG. 2, the variable values (e.g., 323, 324, . . . , 325) associated with an entity ID (322) are considered the random samples of the respective variables (e.g., 311, 313, 315), sampled for the instance of an entity represented by the entity ID (322). Statistical analyses (e.g., factor analysis (327) and cluster analysis (329)) are performed to identify the patterns and correlations in the random samples.

Once the cluster definitions (333) are obtained from the cluster analysis (329), the identity of the cluster (e.g., cluster ID (343)) that contains the entity ID (322) can be used to characterize spending behavior of the entity represented by the entity ID (322). The entities in the same cluster are considered to have similar spending behaviors.

In FIG. 2, the random variables (e.g., 313 and 315) as defined by the definitions (309) have certain degrees of correlation and are not independent from each other. For example, merchants of different merchant categories (e.g., 306) may have overlapping business, or have certain business relationships. For example, certain products and/or services of certain merchants have cause and effect relationships. For example, certain products and/or services of certain merchants are mutually exclusive to a certain degree (e.g., a purchase from one merchant may have a level of probability to exclude the user (101) from making a purchase from another merchant). Such relationships may be complex and difficult to quantify by merely inspecting the categories. Further, such relationships may shift over time as the economy changes.

In FIG. 2, a factor analysis (327) is performed to reduce the redundancy and/or correlation among the variables (e.g., 313, 315). The factor analysis (327) identifies the definitions (331) for factors, each of which represents a combination of the variables (e.g., 313, 315). A factor from the factor analysis (327) is a linear combination of a plurality of the aggregated measurements (e.g., variables (313, 315)) determined for various areas (e.g., merchants or merchant categories, products or product categories). Once the relationship between the factors and the aggregated measurements is determined via factor analysis, the values for the factors can be determined from the linear combinations of the aggregated measurements and be used in a transaction profile (127 or 341) to provide information on the behavior of the entity represented by the entity ID (e.g., an account, an individual, a family).

Once the factor definitions (331) are obtained from the factor analysis (327), the factor definitions (331) can be applied to the variable values (321) to determine factor values (344) for the aggregated spending profile (341). Since redundancy and correlation are reduced in the factors, the number of factors is typically much smaller than the number of the original variables (e.g., 313, 315). Thus, the factor values (344) represent the concise summary of the original variables (e.g., 313, 315).

For example, there may be thousands of variables on spending frequency and amount for different merchant categories; and the factor analysis (327) can reduce the factor number to less than one hundred (and even less than twenty). In one example, a twelve-factor solution is obtained, which allows the use of twelve factors to combine the thousands of the original variables (313, 315); and thus, the spending behavior in thousands of merchant categories can be summarized via twelve factor values (344). In one embodiment, each factor is combination of at least four variables; and a typical variable has contributions to more than one factor.

In FIG. 2, an aggregated spending profile (341) for an entity represented by an entity ID (e.g., 322) includes the cluster ID (343) and factor values (344) determined based on the cluster definitions (333) and the factor definitions (331). The aggregated spending profile (341) may further include other statistical parameters, such as diversity index (342), channel distribution (345), category distribution (346), zip code (347), etc., as further discussed below.

In general, an aggregated spending profile (341) may include more or fewer fields than those illustrated in FIG. 2. For example, in one embodiment, the aggregated spending profile (341) further includes an aggregated spending amount for a period of time (e.g., the past twelve months); in another embodiment, the aggregated spending profile (341) does not include the category distribution (346); and in a further embodiment, the aggregated spending profile (341) may include a set of distance measures to the centroids of the clusters.

FIG. 3 shows a method to generate an aggregated spending profile according to one embodiment. In FIG. 3, computation models are established (351) for variables (e.g., 311, 313, and 315). In one embodiment, the variables are defined in a way to capture certain aspects of the spending statistics, such as frequency, amount, etc.

In FIG. 3, data from related accounts are combined (353); recurrent/installment transactions are combined (355); and account data are selected (357) according to a set of criteria related to activity, consistency, diversity, etc.

In FIG. 3, the computation models (e.g., as represented by the variable definitions (309)) are applied (359) to the remaining account data (e.g., transaction records (301)) to obtain data samples for the variables. The data points associated with the entities, other than those whose transactions fail to meet the minimum requirements for activity, consistency, diversity, etc., are used in factor analysis (327) and cluster analysis (329).

In FIG. 3, the data samples (e.g., variable values (321)) are used to perform (361) factor analysis (327) to identify factor solutions (e.g., factor definitions (331)). The factor solutions can be adjusted (363) to improve similarity in factor values of different sets of transaction data (109).

The data samples can also be used to perform (365) cluster analysis (329) to identify cluster solutions (e.g., cluster definitions (333)). The cluster solutions can be adjusted (367) to improve similarity in cluster identifications based on different sets of transaction data (109). For example, cluster definitions (333) can be applied to the transactions in the time period under analysis (e.g., the past twelve months) and be applied separately to the transactions in a prior time period (e.g., the twelve months before the past twelve months) to obtain two sets of cluster identifications for various entities. The cluster definitions (333) can be adjusted to improve the correlation between the two set of cluster identifications.

Optionally, human understandable characteristics of the factors and clusters are identified (369) to name the factors and clusters. For example, when the spending behavior of a cluster appears to be the behavior of an internet loyalist, the cluster can be named “internet loyalist” such that if a cardholder is found to be in the “internet loyalist” cluster, the spending preferences and patterns of the cardholder can be easily perceived.

In one embodiment, the factor analysis (327) and the cluster analysis (329) are performed periodically (e.g., once a year, or six months) to update the factor definitions (331) and the cluster definitions (333), which may change as the economy and the society change over time.

In FIG. 3, transaction data (109) are summarized (371) using the factor solutions and cluster solutions to generate the aggregated spending profile (341). The aggregated spending profile (341) can be updated more frequently than the factor solutions and cluster solutions, when the new transaction data (109) becomes available. For example, the aggregated spending profile (341) may be updated quarterly or monthly.

Details about aggregated spending profile (341) in one embodiment are provided in U.S. patent application Ser. No. 12/777,173, filed May 10, 2010, assigned U.S. Pat. App. Pub. No. 2010/0306032, and entitled “Systems and Methods to Summarize Transaction Data,” the disclosure of which is hereby incorporated herein by reference.

### Aggregated Region Profile

In one embodiment, a set of profiles (127) is generated from the transaction data (109) to indicate the spending preferences of users (101) residing in different regions, without revealing sensitive private information, such as the spending patterns of individual users (101) or families, the actual spending amounts or frequencies, etc.

In one embodiment, users (101) in a large geographical region (e.g., a continent, a country, a state, a county, a metropolitan area, etc.) are divided into groups based on addresses (e.g., mailing address, street address, residence address, etc.). For example, postal codes can be used to define regions or neighborhoods within the large geographical region; and a user (101) can be classified to be in one of the regions or neighborhoods in accordance with the corresponding address of the user (101). For example, the extended ZIP+4 code can be used to define neighborhoods within United States, where the five-digit ZIP code is used with an additional four-digit code to define a smaller neighborhood. For example, US census block groups can be used to define a level of regions or neighborhoods for the computation of the region profiles. For example, ZIP codes, or metropolitan statistical areas (MSA), can be used to define a level of regions or neighborhoods for the computation of the region profiles.

In one embodiment, a profile for a region is generated based on aggregating the transaction data of a plurality of individuals and/or families to protect the privacy of the individuals and families. For example, when a region includes less than a predetermined number of separate account holders and/or families, the profile is not generated using the transaction data of the small number of account holders and/or families. For example, the profile of such a region having a small number of account holders and/or families may be not computed, may be computed but not provided to a third party, or may be computed but not used in targeted advertisements. In one embodiment, such a region is merged with a neighboring region to form a larger neighborhood that has a number of account holders and/or families that is larger than a predetermined threshold. In one embodiment, a region profile does not represent a particular account holder or family/household.

In one embodiment, when the number of account holders/households in certain ZIP+4 code regions are smaller than a predetermined threshold, the corresponding regions are combined and identified at ZIP+3 code level. For example, the ZIP+4 regions having the same first ZIP+3 digits are combined as a neighborhood. If ZIP+3 regions do not meet the predetermined threshold, ZIP+2 regions are used. Thus, the combination is performed via using less digits from the ZIP+4 codes to from neighborhoods that satisfy the predetermined threshold for the number of account holders/households.

In one embodiment, transactions are aggregated according to a set of preselected merchant categories. In one embodiment, the merchant categories are selected according to clustering of merchant categories and/or correlation of transactions in merchant categories. In one embodiment, a super merchant category is defined to include a plurality of related merchant categories; merchant categories are assigned to a plurality of super merchant categories; and the transactions are aggregated according to the super merchant categories.

In one embodiment, a factor analysis (327) is used to identify factors representing different spending categories based on linear combinations of spending in merchant categories; and the transactions of the users (101) are aggregated according to the factors defined by the factor definitions (331).

In one embodiment, a set of merchant categories is defined to represent a number of market segments, such as department stores, restaurants, retail, travel and entertainment, business to business, automobile, etc.

In one embodiment, the automobile segment includes spending for maintenance and repairs, such as spending at tire stores, automobile parts stores, automobile service shops (e.g., dealers and non dealers). In one embodiment, the business to business segment includes spending on office supplies, office furniture, etc., as identified in business account transaction data. In one embodiment, the travel segment includes spending on air travel, hotels, etc. In one embodiment, the retail segment includes spending on apparel, furniture, electronics, home improvement goods, specialty retail items, sporting goods, etc.

In one embodiment, certain merchant categories are purposely excluded from the profile to enhance privacy protection. For example, in one embodiment, the region profile does not use transactions related to health services, doctors, dentists, beer/wine/liquor, automobile fuel dispensers, colleges/universities, etc.

In one embodiment, the profile (127) for a region/neighborhood is computed based on the weight variables that represent the percentages of aggregated spending in various market segments for the region/neighborhood. The regions are ranked according to the weight variables for individual market segments to determine the percentile variables, and are normalized across the regions to generate the index variables. The profile (127) for the region/neighborhood includes the corresponding values for the corresponding index variables and the percentile variables. Through the normalization process and the ranking process, the actual spending amounts are not presented in the profile (127) and cannot be derived from the index values and/or the percentile values provided in the profile (127).

In one embodiment, the profiles (127) of different regions/neighborhoods include the index values and the percentile values that are indicative of relative spending preferences across the regions within each market segment, and relative spending preferences across the market segments within a region. However, the actual spending amounts cannot be derived from the profiles (127).

In one embodiment, transactions are aggregated within a region and a market segment (or merchant category) in variety of ways to generate different aggregation measurements. Examples of aggregation measurements include:

Total number of transactions in the region and in the market segment

Total transaction amount in the region and in the market segment

Total number of offline transactions in the region and in the market segment

Total amount of offline transactions in the region and in the market segment

Ratio of average total monthly transaction amounts in the region and in the market segment between the last three months and the last twelve months

Ratio of average monthly total number of transactions in the region and in the market segment between the last three months and the last twelve months

Ratio of average total monthly offline transaction amounts in the region and in the market segment between the last three months and the last twelve months

Ratio of average monthly total number of offline transactions in the region and in the market segment between the last three months and the last twelve months

In one embodiment, an aggregation measurement is normalized and ranked across the regions for a market segment to generate index and percentile values without first being normalized across the market segments for individual regions.

In one embodiment, an aggregation measurement is normalized and ranked across the regions for a market segment to generate index and percentile values after first being normalized across the market segments for individual regions. For example, the aggregated transactions (e.g., transaction amount or number of transactions) in various market segments can be normalized for a region by utilizing the total aggregated transactions in all of the market segments (e.g., by determining the percentage of the aggregated transactions in individual market segments for the region). For example, the aggregated offline transactions in various market segments for a region can be normalized with the aggregated offline transactions in all market segments for the region, or normalized with the aggregated transactions in all market segments for the region (e.g., including online transactions, offline transactions).

In one embodiment, the profile for a region further includes the values corresponding to the weight variables, such as the percentage distribution of the aggregated transactions in various market segments for individual regions.

In one embodiment, the profiles for the regions are used for marketing and advertising purposes. For example, the profiles for the regions can be used to help marketers/advertisers identify neighborhoods in which they may want to offer specific products and services, drive traffic to a specific store location, understand where to and where not to open a new store location, etc.

In one embodiment, the profiles for the regions provide insight at the neighborhood level to help improve the products and services that merchants or manufactures are already selling to their clients.

For example, the region profiles can be used to help a fast food chain identify a proposed location that has an above average history of purchasing fast food. The region profiles, along with other data and analytics, can be used to provide the fast food chain with insight into the proposed location.

In one embodiment, the region profiles are used for advertisement targeting and the determination of targets of marketing actions such as online advertising, direct mail or TV ads. The region profiles provide a marketer with insight into certain behaviors or characteristics of the population it wants to target. Typically, demographic characteristics of consumers are used in advertisement targeting, based on the assumption that the demographic characteristics of a consumer correspond to the consumer's spending behavior. A further dimension of targeting is that a marketer may only know the demographic characteristics of consumers within a small geographic area, such as a region identified by a ZIP+4 code, and the advertisement targeting is based on the assumption that consumers within the small geographical area (e.g., a region identified by a ZIP+4 code) are alike.

In one embodiment, the region profiles are created at the level of small geographical areas (e.g., ZIP+4 level, ZIP level, metropolitan statistical area level, US census block group level) to identify the typical spending characteristics of the users (101) in the respective areas.

For example, in one embodiment, the proportions of spending of a group of accounts within a ZIP+4 region in one or more industries are ranked, indexed and compared to all other ZIP+4 regions. If a certain ZIP+4 region spends 20% of their total spending amount on apparel, and the national average is 10%, then that ZIP+4 would index at 200 (assuming the average for all ZIP+4s is set at 100) (e.g., 100×20%/10%=200). A marketer could combine demographic data at a ZIP+4 level with the actual spending behavior at the ZIP+4 level to improve the quality of the targeting by largely eliminating the assumption that all consumers with the same demographic characteristics would exhibit the same spending behavior.

For example, if a marketer wants to target all females between the ages of 35 and 44 to advertise for apparel shopping, the region profiles allow the marketer to identify which ZIP+4 regions have a high proportion of females between the ages of 35 and 44, and then identify which subset of those ZIP+4 regions tend to index high on apparel shopping. Thus, the marketer can target the subset of ZIP+4 regions.

For example, the same marketer, by looking at the ZIP+4 regions which index very high for apparel shopping, may find ZIP+4 regions which do not have a high proportion of females between the ages and 35 and 44, thus identifying possible targeting opportunities they did not know existed.

In one embodiment, the change of the region profiles over time can be used to quantify the audience and evaluate the campaign performance, when the advertisements are directed to one or more ZIP+4 regions.

FIG. 12 shows a method to summarize transaction data for geographic regions according to one embodiment. In FIG. 12, the transaction data (109) is aggregated according to categories (211, 213, . . . , 219) and regions (221, 223, . . . , 229). For example, transactions in the category (213) made by users (101) having addresses inside the region (223) are aggregated to determine the aggregated spending (233). Examples of the aggregated spending (233) include the total number of transactions within a predetermined period of time (e.g., in the past twelve months, in the past two years, etc.), the total amount of the transactions within the predetermined period of time, the total number or amount of transactions made via a particular type of transaction channel (e.g., online, offline, phone), the ratio of different aggregation measurements, such as the ratio of total number or amount of transactions between those aggregated within a first period of time (e.g., last three months) and those aggregated within a second period of time (e.g., last twelve months), and the ratio of total number or amount of transactions between those performed in a particular purchase channel (e.g., online or offline) and those performed in a set of purchase channels (e.g., all channels), etc.

In FIG. 12, the aggregated spending measurements (e.g., 231, 233, . . . , 239) are normalized across categories for individual regions (e.g., 223) to obtain normalized measurements, such as percentages (251, 253, . . . , 259) of spending in respective categories (211, 213, . . . , 219) relative to the total spending in the entire set of categories (211, 213, . . . , 219).

In one embodiment, after the normalization across the categories for individual regions (e.g., 223), the spending distributions across categories for individual regions (e.g., percentages (251, 253, . . . , 259) for region (223)) have the same average value (e.g., 1/the number of categories). Thus, the actual magnitudes of the aggregated spending measurements are eliminated.

In FIG. 12, the normalized aggregated spending measurements that are normalized across the categories are sorted for individual categories to determine the percentiles (281, 283, . . . , 289) of the regions (221, 223, . . . , 229). For example, the percentages (243, 253, . . . , 273) for regions (221, 223, . . . , 229) in category (213) can be sorted to determine the percentiles (281, 283, . . . , 289) of the regions (221, 223, . . . , 229) in the percentage measurement for category (213).

In FIG. 12, the normalized aggregated spending measurements that are normalized across the categories are also normalized across the regions (221, 223, . . . , 229) to generate the indices (291, 293, . . . , 299) for the respective regions (221, 223, . . . , 229). After the normalization across the regions for individual categories (e.g., 213), the spending distributions across regions for individual categories (e.g., indices (291, 293, . . , 299) for category (213)) have the same average value (e.g., 1/the number of regions).

In one embodiment, the normalization across regions is performed based on the result of the sorting operation. Alternatively, the sorting operation can be performed based on the result of the normalization across regions. Alternatively, the sorting operation and the normalization across regions can be both performed separately based on the result of the normalization across categories. It is observed that the order of the sorting operation and the normalization across regions has no impact on the resulting indices (291, 293, . . . , 299) and the resulting percentiles (281, 283, . . . , 289).

In one embodiment, certain aggregated measurements are normalized both across the categories and across the regions to form the indices (e.g., 291, 293, . . . , 299). In one embodiment, normalization across the categories is performed prior to the normalization across the regions. In one embodiment, normalization across the regions is performed prior to the normalization across the categories.

In one embodiment, certain aggregated measurements are normalized across the categories but not across the regions to form the indices (e.g., 291, 293, . . . 299). In one embodiment, certain aggregated measurements are normalized across the regions but not across the categories to form the indices (e.g., 291, 293, . . . 299).

FIG. 13 illustrates a profile for a geographic region according to one embodiment. In one embodiment, a spending profile (481) for a region includes a set of values for index 465) and a set of values for percentile (467). The set of values for index (465) includes indices (415, 425, . . . , 455) forming a distribution across the categories (211, 213, . . . , 219). The set of values for percentile (467) includes percentiles (417, 427, . . . , 457) forming a distribution across the categories (211, 213, . . , 219). The distributions across the categories (211, 213, . . . , 219) are representative of the spending preferences across the market segments represented by the categories (211, 213, . . . , 219). The magnitudes of the indices (e.g., 415) or percentiles (e.g., 417) are indicative of the spending preferences of the region (e.g., 221) in comparison with other regions (223, . . . , 229).

The profile (481) can be used in various ways that are described in various sections of the disclosure in connection with profiles (127, 131, and/or 341).

In one embodiment, the profile (481) provides aggregated and anonymous transactional geographic insights that marketers and advertisers can use to enhance their existing marketing and advertising strategies. For example, the profile (481) can be used for site planning, marketing analytics, digital advertising, advertisement effectiveness measurement, etc.

For example, a merchant can used the profile (481) in selecting a site for retail store, for real estate planning. The profile (481) can provide insights to support multi-channel marketing, fuel acquisition models and analytics, improve ability to measure the effectiveness of advertisement, facilitating targeting of digital advertising.

When the profile (481) is used for merchant site selection and planning, the customers can have better store locations and hours. The customers can obtain the right offers at the right time via the right communication channels, since mass advertising can be reduced or avoided. The profile (481) can be used to provide more appropriate and appealing offers and/or relevant advertisements users.

FIG. 14 shows a method to generate region profiles according to one embodiment. In FIG. 14, a computing apparatus is configured to aggregate (501) transactions according to merchant categories (211, 213, . . . , 219) and regions (221, 223, . . . , 229) to generate aggregated transaction measurements (e.g., 231, 233, . . . , 239), normalize (501) the aggregated transaction measurements (e.g., 231, 233, . . . , 239) across the merchant categories (211, 213, . . . , 219) and/or across the regions (221, 223, . . . , 229) to generate indices (e.g., 291, 293, . . . , 299), and rank (505) the regions (221, 223, . . . , 229) in each category (e.g., 213) according to the indices (e.g., 291, 293, . . , 299) to generate percentiles (281, 283, . . . , 289) for the regions (221, 223, . . . , 229).

In one embodiment, the computing apparatus includes at least one of: the profile generator (121), the data warehouse (149), the portal (143), the transaction handler (103), the profile selector (129), the advertisement selector (133), and the media controller (115).

In one embodiment, the computing apparatus is configured to store transaction data (109) of users residing in a plurality of different regions (221, . . . , 229); and generate a transaction profile (481) for each respective region (e.g., 221, . . . , or 229) in the plurality of regions (221, . . . , 229) using the transaction data (109), via: aggregating transactions of users residing in the each respective region (e.g., 223) in each respective merchant category (e.g., 211, . . . , or 219) in a plurality of merchant categories (e.g., 211, . . . , 219) to generate aggregated measurements (e.g., 231, . . . , 239) aggregated according to the regions (e.g., 223) and aggregated according to the merchant categories (211, . . . , 219); normalizing the aggregated measurements across at least one of: the regions and the merchant categories, to generate index measurements (e.g., 291, . . . , 299); and ranking the regions based on the aggregated measurements as normalized across the merchant categories (243, 253, . . . , 273) to generate percentile measurements (281, . . . , 289), where the transaction profile (481) include the index measurements (415, 425, . . . , 455) and the percentile measurements (417, 427, . . . , 457).

In one embodiment, the different regions (221, 223, . . . , 229) are configured and/or identified in accordance with postal codes, such as zip codes and four-digital suffixes to the zip codes in the United States.

In one embodiment, the each respective region (221, 223, . . . , 229) is configured to include users from more than a predetermined threshold number of households, such that when the transactions from different households are aggregated, normalized and/or ranked to identify percentiles for the transaction profile (481), the privacy of the users and/or families is protected.

In one embodiment, the different regions (221, 223, . . . , 229) are configured in accordance with at least one of: census block groups, postal codes, and metropolitan statistical areas.

In one embodiment, the transaction profile (481) is generated via: aggregating transactions (e.g., as identified by the transaction records (301)) according to the merchant categories (306) for each of the regions (221, . . . , 229) to generate aggregated transaction measurements (231, . . . , 239); normalizing the aggregated transaction measurements (231, . . . , 239) across the merchant categories (211, . . . , 219) for each of the regions (e.g., 223) to generate first normalized spending indicators (251, . . . , 259); normalizing the first normalized spending indicators (251, . . . , 259) across the regions (221, . . . , 229) for each of the merchant categories to generate second normalized spending indicators (243, 253, . . . , 273); and generating rank indicators (281, . . . , 289) based on ranking the regions (221, . . . , 229) according to the first normalized spending indicators (243, 253, . . . , 273) in each of the merchant categories (221, . . . , 229).

In one embodiment, the index measurements (465) in the transaction profile (481) include a subset of the second normalized spending indicators (415, 425, . . . , 455) corresponding to the merchant categories (211, 213, . . . , 219) and the respective region (e.g., 221, . . . , or 229).

In one embodiment, the percentile measurements (467) include a subset of the rank indicators (417, 427, . . . , 457) corresponding to the merchant categories (211, 213, . . . , 219) and the respective region (e.g., 221, . . . , or 229).

In one embodiment, a subset of the rank indicators (e.g., 281, . . . , 289) corresponding to the respective merchant category (e.g., 213) represents a percentile distribution of the regions (e.g., 221, . . . , 229) ranked according to the first normalized spending indicators (e.g., 243, 253, . . . , 273) for the respective merchant category (e.g., 213).

In one embodiment, a subset of the rank indicators (e.g., 281, . . . , 289) corresponding to the respective merchant category (e.g., 213) represents a percentile distribution of the regions (e.g., 221, . . . , 229) ranked according to the second normalized spending indicators (e.g., 291, . . . , 299) for the respective merchant category (e.g., 213).

In one embodiment, a subset of the first normalized spending indicators (e.g., 251, 253, . . . , 259) corresponding to the respective region (e.g., 223) represents a percentage distribution of aggregated spending of users residing in the respective region (e.g., 223) across merchant categories (211, . . . , 219) associated with the first normalized spending indicators (e.g., 251, 253, . . . , 259) in the subset.

In one embodiment, the aggregated transaction measurements (e.g., 231, 233, . . . 239) represent one of: aggregated transaction amount, aggregated number of transactions, and transaction frequency. In one embodiment, the indexes (465) and percentiles (467) include different sets of parameters computed based on different aggregation variables, such as aggregated transaction amount, aggregated number of transactions, and transaction frequency.

In one embodiment, the computing apparatus is configured to provide the transaction profile (481) to facilitate at least one of: site planning for a retail store of a merchant; targeting digital advertising; and reducing mass advertising.

In one embodiment, the computing apparatus includes at least one processor (173), and a memory (167) storing instructions configured to instruct the at least one processor (173) to: store transaction data (109) recording transactions processed by a transaction handler (103) coupled with a plurality of issuer processors (e.g., 145) and a plurality of acquirer processors (e.g., 147); aggregate the transactions (e.g., as identified by the transaction records (301)), in accordance with regions (e.g., 221, . . . , 229) in which users (e.g., 101) of consumer accounts (e.g., 146) in which the transactions occurred reside and in accordance with merchant categories (e.g., 306) of the transactions, to generate aggregated measurements (e.g., 231, . . . , 239) for the regions (e.g., 223) and the merchant categories (e.g., 211, . . . , 219); and generate a transaction profile (e.g., 481) for each respective region (e.g., 221, . . . , or 229) in the regions based on 1) normalizing the aggregated measurements, and 2) ranking the regions in accordance with a result (e.g., 251, . . . , 259, 243, 253, . . . , 273, 291, 293, . . . , 299) of the normalizing of the aggregated measurements.

In one embodiment, the normalizing of the aggregated measurements (e.g., 231, . . . , 239) includes: normalizing, for each of the regions, the aggregated measurements (e.g., 231, . . . , 239) across the merchant categories (211, . . . , 219) to generate normalized aggregated measurements (251, . . . , 259) for spending in the merchant categories (211, . . . , 219) by users (e.g., 101) residing the each respective region (e.g., 223); and normalizing, for each of the merchant categories (211, . . . , 219), the normalized aggregated measurements (243, 253, . . . , 273) across the regions (221, . . , 229) to generate aggregated spending indexes (e.g., 291, . . . , 299) for spending in the each respective merchant category (e.g., 213) by users residing the each respective region (e.g., 281, . . . , or 289).

In one embodiment, the ranking of the regions is based on the normalized aggregated measurements (243, 253, . . . , 273) to generate percentile ranks (281, . . . , 289) of the regions (221, . . . , 229) in the each respective merchant category (213).

In one embodiment, the transaction profile (481) for the respective region (e.g., 221, . . . , or 229) includes the spending indexes (e.g., 415, 425, . . . , 455) of the merchant categories (211, . . . , 219) for the respective region and the percentile ranks (417, 427, . . . , 457) of the respective region (e.g., 221, . . . , or 229) in the merchant categories (211, . . . , 219).

In one embodiment, a computer-storage medium stores instructions configured to instruct the computing apparatus to: store, in the computing apparatus, transaction data (109) of transactions in consumer accounts (e.g., 146) and location data (e.g., in account data (111)) of users (e.g., 101) of the consumer accounts (e.g., 146); generate, by the computing apparatus, aggregated transaction measurements (e.g., 231, . . . , 239) by aggregating the transactions according to merchant categories of the transactions and according to regions (221, . . . , 229) in which users (e.g., 101) of the transactions reside; normalize, by the computing apparatus, the aggregated transaction measurements (e.g., 231, . . . , 239) across the merchant categories (211, . . . , 219) to generate first normalized spending indicators (e.g., 251, . . . , 259, 243, 253, . . . , 273) for each of the regions (e.g., 221, 223, . . . , 229); normalize, by the computing apparatus, the first normalized spending indicators (e.g., 243, 253, . . . , 273) across the regions (221, . . . , 229) to generate second normalized spending indicators (291, . . . , 299) for each of the merchant categories (e.g., 213); rank, by the computing apparatus, the regions (221, . . . , 229) according to the first normalized spending indicators (243, 253, . . . , 273) to generate region percentile indicators (e.g., 281, . . . , 289) for each of the merchant categories (e.g., 221); and generate, by the computing apparatus, a transaction profile (481) for each respective region (e.g., 221, . . . , or 229) in the plurality of regions (221, . . , 229), where for the each respective region the transaction profile includes the second normalized spending indicators (e.g., 415, 425, . . . , 455) for aggregated spending in the merchant categories (211, . . . , 219), and the region percentile indicators (417, 427, . . . , 457) of the merchant categories (211, . . . , 219).

In one embodiment, the regions (221, . . . , 229) are defined based on zip codes and suffixes to the zip codes in the United States; and each of the regions (221, . . , 229) is configured to have users from more than a predetermined threshold number of households.

### Transaction Data Based Portal

In FIG. 1, the transaction terminal (105) initiates the transaction for a user (101) (e.g., a customer) for processing by a transaction handler (103). The transaction handler (103) processes the transaction and stores transaction data (109) about the transaction, in connection with account data (111), such as the account profile of an account of the user (101). The account data (111) may further include data about the user (101), collected from issuers or merchants, and/or other sources, such as social networks, credit bureaus, merchant provided information, address information, etc. In one embodiment, a transaction may be initiated by a server (e.g., based on a stored schedule for recurrent payments).

The accumulated transaction data (109) and the corresponding account data (111) are used to generate intelligence information about the purchase behavior, pattern, preference, tendency, frequency, trend, amount and/or propensity of the users (e.g., 101), as individuals or as a member of a group. The intelligence information can then be used to generate, identify and/or select targeted advertisements for presentation to the user (101) on the point of interaction (107), during a transaction, after a transaction, or when other opportunities arise.

In FIG. 4, the consumer account (146) is under the control of the issuer processor (145). The consumer account (146) may be owned by an individual, or an organization such as a business, a school, etc. The consumer account (146) may be a credit account, a debit account, or a stored value account. The issuer may provide the consumer (e.g., user (101)) an account identification device (141) to identify the consumer account (146) using the account information (142). The respective consumer of the account (146) can be called an account holder or a cardholder, even when the consumer is not physically issued a card, or the account identification device (141), in one embodiment. The issuer processor (145) is to charge the consumer account (146) to pay for purchases.

The account identification device (141) of one embodiment is a plastic card having a magnetic strip storing account information (142) identifying the consumer account (146) and/or the issuer processor (145). Alternatively, the account identification device (141) is a smartcard having an integrated circuit chip storing at least the account information (142). The account identification device (141) may optionally include a mobile phone having an integrated smartcard.

The account information (142) may be printed or embossed on the account identification device (141). The account information (142) may be printed as a bar code to allow the transaction terminal (105) to read the information via an optical scanner. The account information (142) may be stored in a memory of the account identification device (141) and configured to be read via wireless, contactless communications, such as near field communications via magnetic field coupling, infrared communications, or radio frequency communications. Alternatively, the transaction terminal (105) may require contact with the account identification device (141) to read the account information (142) (e.g., by reading the magnetic strip of a card with a magnetic strip reader).

The transaction terminal (105) is configured to transmit an authorization request message to the acquirer processor (147). The authorization request includes the account information (142), an amount of payment, and information about the merchant (e.g., an indication of the merchant account (148)). The acquirer processor (147) requests the transaction handler (103) to process the authorization request, based on the account information (142) received in the transaction terminal (105). The transaction handler (103) routes the authorization request to the issuer processor (145) and may process and respond to the authorization request when the issuer processor (145) is not available. The issuer processor (145) determines whether to authorize the transaction based at least in part on a balance of the consumer account (146).

The transaction handler (103), the issuer processor (145), and the acquirer processor (147) may each include a subsystem to identify the risk in the transaction and may reject the transaction based on the risk assessment.

The account identification device (141) may include security features to prevent unauthorized uses of the consumer account (146), such as a logo to show the authenticity of the account identification device (141), encryption to protect the account information (142), etc.

The transaction terminal (105) of one embodiment is configured to interact with the account identification device (141) to obtain the account information (142) that identifies the consumer account (146) and/or the issuer processor (145). The transaction terminal (105) communicates with the acquirer processor (147) that controls the merchant account (148) of a merchant. The transaction terminal (105) may communicate with the acquirer processor (147) via a data communication connection, such as a telephone connection, an Internet connection, etc. The acquirer processor (147) is to collect payments into the merchant account (148) on behalf of the merchant.

In one embodiment, the transaction terminal (105) is a POS terminal at a traditional, offline, “brick and mortar” retail store. In another embodiment, the transaction terminal (105) is an online server that receives account information (142) of the consumer account (146) from the user (101) through a web connection. In one embodiment, the user (101) may provide account information (142) through a telephone call, via verbal communications with a representative of the merchant; and the representative enters the account information (142) into the transaction terminal (105) to initiate the transaction.

In one embodiment, the account information (142) can be entered directly into the transaction terminal (105) to make payment from the consumer account (146), without having to physically present the account identification device (141). When a transaction is initiated without physically presenting an account identification device (141), the transaction is classified as a “card-not-present” (CNP) transaction.

In general, the issuer processor (145) may control more than one consumer account (146); the acquirer processor (147) may control more than one merchant account (148); and the transaction handler (103) is connected between a plurality of issuer processors (e.g., 145) and a plurality of acquirer processors (e.g., 147). An entity (e.g., bank) may operate both an issuer processor (145) and an acquirer processor (147).

In one embodiment, the transaction handler (103), the issuer processor (145), the acquirer processor (147), the transaction terminal (105), the portal (143), and other devices and/or services accessing the portal (143) are connected via communications networks, such as local area networks, cellular telecommunications networks, wireless wide area networks, wireless local area networks, an intranet, and Internet. Dedicated communication channels may be used between the transaction handler (103) and the issuer processor (145), between the transaction handler (103) and the acquirer processor (147), and/or between the portal (143) and the transaction handler (103).

In FIG. 4, the transaction handler (103) uses the data warehouse (149) to store the records about the transactions, such as the transaction records (301) or transaction data (109).

Typically, the transaction handler (103) is implemented using a powerful computer, or cluster of computers functioning as a unit, controlled by instructions stored on a computer readable medium. The transaction handler (103) is configured to support and deliver authorization services, exception file services, and clearing and settlement services. The transaction handler (103) has a subsystem to process authorization requests and another subsystem to perform clearing and settlement services. The transaction handler (103) is configured to process different types of transactions, such credit card transactions, debit card transactions, prepaid card transactions, and other types of commercial transactions. The transaction handler (103) interconnects the issuer processors (e.g., 145) and the acquirer processor (e.g., 147) to facilitate payment communications.

In FIG. 4, the transaction terminal (105) is configured to submit the authorized transactions to the acquirer processor (147) for settlement. The amount for the settlement may be different from the amount specified in the authorization request. The transaction handler (103) is coupled between the issuer processor (145) and the acquirer processor (147) to facilitate the clearing and settling of the transaction. Clearing includes the exchange of financial information between the issuer processor (145) and the acquirer processor (147); and settlement includes the exchange of funds.

In FIG. 4, the issuer processor (145) is configured to provide funds to make payments on behalf of the consumer account (146). The acquirer processor (147) is to receive the funds on behalf of the merchant account (148). The issuer processor (145) and the acquirer processor (147) communicate with the transaction handler (103) to coordinate the transfer of funds for the transaction. The funds can be transferred electronically.

The transaction terminal (105) may submit a transaction directly for settlement, without having to separately submit an authorization request.

In one embodiment, the portal (143) provides a user interface to allow the user (101) to organize the transactions in one or more consumer accounts (146) of the user with one or more issuers. The user (101) may organize the transactions using information and/or categories identified in the transaction records (301), such as merchant category (306), transaction date (303), amount (304), etc. Examples and techniques in one embodiment are provided in U.S. patent application Ser. No. 11/378,215, filed Mar. 16, 2006, assigned U.S. Pat. App. Pub. No. 2007/0055597, and entitled “Method and System for Manipulating Purchase Information,” the disclosure of which is hereby incorporated herein by reference.

In one embodiment, the portal (143) provides transaction based statistics, such as indicators for retail spending monitoring, indicators for merchant benchmarking, industry/market segmentation, indicators of spending patterns, etc. Further examples can be found in U.S. patent application Ser. No. 12/191,796, filed Aug. 14, 2008, assigned U.S. Pat. App. Pub. No. 2009/0048884, and entitled “Merchant Benchmarking Tool,” U.S. patent application Ser. No. 12/940,562, filed Nov. 5, 2010, and U.S. patent application Ser. No. 12/940,664, filed Nov. 5, 2010, the disclosures of which applications are hereby incorporated herein by reference.

### Transaction Terminal

FIG. 5 illustrates a transaction terminal according to one embodiment. The transaction terminal (105) illustrated in FIG. 5 can be used in various systems discussed in connection with other figures of the present disclosure. In FIG. 5, the transaction terminal (105) is configured to interact with an account identification device (141) to obtain account information (142) about the consumer account (146).

In one embodiment, the transaction terminal (105) includes a memory (167) coupled to the processor (151), which controls the operations of a reader (163), an input device (153), an output device (165) and a network interface (161). The memory (167) may store instructions for the processor (151) and/or data, such as an identification that is associated with the merchant account (148).

In one embodiment, the reader (163) includes a magnetic strip reader. In another embodiment, the reader (163) includes a contactless reader, such as a radio frequency identification (RFID) reader, a near field communications (NFC) device configured to read data via magnetic field coupling (in accordance with ISO standard 14443/NFC), a Bluetooth transceiver, a WiFi transceiver, an infrared transceiver, a laser scanner, etc.

In one embodiment, the input device (153) includes key buttons that can be used to enter the account information (142) directly into the transaction terminal (105) without the physical presence of the account identification device (141). The input device (153) can be configured to provide further information to initiate a transaction, such as a personal identification number (PIN), password, zip code, etc. that may be used to access the account identification device (141), or in combination with the account information (142) obtained from the account identification device (141).

In one embodiment, the output device (165) may include a display, a speaker, and/or a printer to present information, such as the result of an authorization request, a receipt for the transaction, an advertisement, etc.

In one embodiment, the network interface (161) is configured to communicate with the acquirer processor (147) via a telephone connection, an Internet connection, or a dedicated data communication channel.

In one embodiment, the instructions stored in the memory (167) are configured at least to cause the transaction terminal (105) to send an authorization request message to the acquirer processor (147) to initiate a transaction. The transaction terminal (105) may or may not send a separate request for the clearing and settling of the transaction. The instructions stored in the memory (167) are also configured to cause the transaction terminal (105) to perform other types of functions discussed in this description.

In one embodiment, a transaction terminal (105) may have fewer components than those illustrated in FIG. 5. For example, in one embodiment, the transaction terminal (105) is configured for “card-not-present” transactions; and the transaction terminal (105) does not have a reader (163).

In one embodiment, a transaction terminal (105) may have more components than those illustrated in FIG. 5. For example, in one embodiment, the transaction terminal (105) is an ATM machine, which includes components to dispense cash under certain conditions.

### Account Identification Device

FIG. 6 illustrates an account identifying device according to one embodiment. In FIG. 6, the account identification device (141) is configured to carry account information (142) that identifies the consumer account (146).

In one embodiment, the account identification device (141) includes a memory (167) coupled to the processor (151), which controls the operations of a communication device (159), an input device (153), an audio device (157) and a display device (155). The memory (167) may store instructions for the processor (151) and/or data, such as the account information (142) associated with the consumer account (146).

In one embodiment, the account information (142) includes an identifier identifying the issuer (and thus the issuer processor (145)) among a plurality of issuers, and an identifier identifying the consumer account among a plurality of consumer accounts controlled by the issuer processor (145). The account information (142) may include an expiration date of the account identification device (141), the name of the consumer holding the consumer account (146), and/or an identifier identifying the account identification device (141) among a plurality of account identification devices associated with the consumer account (146).

In one embodiment, the account information (142) may further include a loyalty program account number, accumulated rewards of the consumer in the loyalty program, an address of the consumer, a balance of the consumer account (146), transit information (e.g., a subway or train pass), access information (e.g., access badges), and/or consumer information (e.g., name, date of birth), etc.

In one embodiment, the memory includes a nonvolatile memory, such as magnetic strip, a memory chip, a flash memory, a Read Only Memory (ROM), etc. to store the account information (142).

In one embodiment, the information stored in the memory (167) of the account identification device (141) may also be in the form of data tracks that are traditionally associated with credits cards. Such tracks include Track 1 and Track 2. Track 1 (“International Air Transport Association”) stores more information than Track 2, and contains the cardholder's name as well as the account number and other discretionary data. Track 1 is sometimes used by airlines when securing reservations with a credit card. Track 2 (“American Banking Association”) is currently most commonly used and is read by ATMs and credit card checkers. The ABA (American Banking Association) designed the specifications of Track 1 and banks abide by it. It contains the cardholder's account number, encrypted PIN, and other discretionary data.

In one embodiment, the communication device (159) includes a semiconductor chip to implement a transceiver for communication with the reader (163) and an antenna to provide and/or receive wireless signals.

In one embodiment, the communication device (159) is configured to communicate with the reader (163). The communication device (159) may include a transmitter to transmit the account information (142) via wireless transmissions, such as radio frequency signals, magnetic coupling, or infrared, Bluetooth or WiFi signals, etc.

In one embodiment, the account identification device (141) is in the form of a mobile phone, personal digital assistant (PDA), etc. The input device (153) can be used to provide input to the processor (151) to control the operation of the account identification device (141); and the audio device (157) and the display device (155) may present status information and/or other information, such as advertisements or offers. The account identification device (141) may include further components that are not shown in FIG. 6, such as a cellular communications subsystem.

In one embodiment, the communication device (159) may access the account information (142) stored on the memory (167) without going through the processor (151).

In one embodiment, the account identification device (141) has fewer components than those illustrated in FIG. 6. For example, an account identification device (141) does not have the input device (153), the audio device (157) and the display device (155) in one embodiment; and in another embodiment, an account identification device (141) does not have components (151-159).

For example, in one embodiment, an account identification device (141) is in the form of a debit card, a credit card, a smartcard, or a consumer device that has optional features such as magnetic strips, or smartcards.

An example of an account identification device (141) is a magnetic strip attached to a plastic substrate in the form of a card. The magnetic strip is used as the memory (167) of the account identification device (141) to provide the account information (142). Consumer information, such as account number, expiration date, and consumer name may be printed or embossed on the card. A semiconductor chip implementing the memory (167) and the communication device (159) may also be embedded in the plastic card to provide account information (142) in one embodiment.

In one embodiment, the account identification device (141) has the semiconductor chip but not the magnetic strip.

In one embodiment, the account identification device (141) is integrated with a security device, such as an access card, a radio frequency identification (RFID) tag, a security card, a transponder, etc.

In one embodiment, the account identification device (141) is a handheld and compact device. In one embodiment, the account identification device (141) has a size suitable to be placed in a wallet or pocket of the consumer.

Some examples of an account identification device (141) include a credit card, a debit card, a stored value device, a payment card, a gift card, a smartcard, a smart media card, a payroll card, a health care card, a wrist band, a keychain device, a supermarket discount card, a transponder, and a machine readable medium containing account information (142).

### Point of Interaction

In one embodiment, the point of interaction (107) is to provide an advertisement to the user (101), or to provide information derived from the transaction data (109) to the user (101).

In one embodiment, an advertisement is a marketing interaction which may include an announcement and/or an offer of a benefit, such as a discount, incentive, reward, coupon, gift, cash back, or opportunity (e.g., special ticket/admission). An advertisement may include an offer of a product or service, an announcement of a product or service, or a presentation of a brand of products or services, or a notice of events, facts, opinions, etc. The advertisements can be presented in text, graphics, audio, video, or animation, and as printed matter, web content, interactive media, etc. An advertisement may be presented in response to the presence of a financial transaction card, or in response to a financial transaction card being used to make a financial transaction, or in response to other user activities, such as browsing a web page, submitting a search request, communicating online, entering a wireless communication zone, etc. In one embodiment, the presentation of advertisements may be not a result of a user action.

In one embodiment, the point of interaction (107) can be one of various endpoints of the transaction network, such as point of sale (POS) terminals, automated teller machines (ATMs), electronic kiosks (or computer kiosks or interactive kiosks), self-assist checkout terminals, vending machines, gas pumps, websites of banks (e.g., issuer banks or acquirer banks of credit cards), bank statements (e.g., credit card statements), websites of the transaction handler (103), websites of merchants, checkout websites or web pages for online purchases, etc.

In one embodiment, the point of interaction (107) may be the same as the transaction terminal (105), such as a point of sale (POS) terminal, an automated teller machine (ATM), a mobile phone, a computer of the user for an online transaction, etc. In one embodiment, the point of interaction (107) may be co-located with, or near, the transaction terminal (105) (e.g., a video monitor or display, a digital sign), or produced by the transaction terminal (e.g., a receipt produced by the transaction terminal (105)). In one embodiment, the point of interaction (107) may be separate from and not co-located with the transaction terminal (105), such as a mobile phone, a personal digital assistant, a personal computer of the user, a voice mail box of the user, an email inbox of the user, a digital sign, etc.

For example, the advertisements can be presented on a portion of media for a transaction with the customer, which portion might otherwise be unused and thus referred to as a “white space” herein. A white space can be on a printed matter (e.g., a receipt printed for the transaction, or a printed credit card statement), on a video display (e.g., a display monitor of a POS terminal for a retail transaction, an ATM for cash withdrawal or money transfer, a personal computer of the customer for online purchases), or on an audio channel (e.g., an interactive voice response (IVR) system for a transaction over a telephonic device).

In one embodiment, the white space is part of a media channel available to present a message from the transaction handler (103) in connection with the processing of a transaction of the user (101). In one embodiment, the white space is in a media channel that is used to report information about a transaction of the user (101), such as an authorization status, a confirmation message, a verification message, a user interface to verify a password for the online use of the account information (142), a monthly statement, an alert or a report, or a web page provided by the portal (143) to access a loyalty program associated with the consumer account (146) or a registration program.

In other embodiments, the advertisements can also be presented via other media channels which may not involve a transaction processed by the transaction handler (103). For example, the advertisements can be presented on publications or announcements (e.g., newspapers, magazines, books, directories, radio broadcasts, television, digital signage, etc., which may be in an electronic form, or in a printed or painted form). The advertisements may be presented on paper, on websites, on billboards, on digital signs, or on audio portals.

In one embodiment, the transaction handler (103) purchases the rights to use the media channels from the owner or operators of the media channels and uses the media channels as advertisement spaces. For example, white spaces at a point of interaction (e.g., 107) with customers for transactions processed by the transaction handler (103) can be used to deliver advertisements relevant to the customers conducting the transactions; and the advertisement can be selected based at least in part on the intelligence information derived from the accumulated transaction data (109) and/or the context at the point of interaction (107) and/or the transaction terminal (105).

In general, a point of interaction (e.g., 107) may or may not be capable of receiving inputs from the customers, and may or may not co-located with a transaction terminal (e.g., 105) that initiates the transactions. The white spaces for presenting the advertisement on the point of interaction (107) may be on a portion of a geographical display space (e.g., on a screen), or on a temporal space (e.g., in an audio stream).

In one embodiment, the point of interaction (107) may be used to primarily to access services not provided by the transaction handler (103), such as services provided by a search engine, a social networking website, an online marketplace, a blog, a news site, a television program provider, a radio station, a satellite, a publisher, etc.

In one embodiment, a consumer device is used as the point of interaction (107), which may be a non-portable consumer device or a portable computing device. The consumer device is to provide media content to the user (101) and may receive input from the user (101).

Examples of non-portable consumer devices include a computer terminal, a television set, a personal computer, a set-top box, or the like. Examples of portable consumer devices include a portable computer, a cellular phone, a personal digital assistant (PDA), a pager, a security card, a wireless terminal, or the like. The consumer device may be implemented as a data processing system as illustrated in FIG. 7, with more or fewer components.

In one embodiment, the consumer device includes an account identification device (141). For example, a smart card used as an account identification device (141) is integrated with a mobile phone, or a personal digital assistant (PDA).

In one embodiment, the point of interaction (107) is integrated with a transaction terminal (105). For example, a self-service checkout terminal includes a touch pad to interact with the user (101); and an ATM machine includes a user interface subsystem to interact with the user (101).

### Hardware

In one embodiment, a computing apparatus is configured to include some of the components of systems illustrated in various figures, such as the transaction handler (103), the profile generator (121), the media controller (115), the portal (143), the profile selector (129), the advertisement selector (133), the user tracker (113), the correlator, and their associated storage devices, such as the data warehouse (149).

In one embodiment, at least some of the components such as the transaction handler (103), the transaction terminal (105), the point of interaction (107), the user tracker (113), the media controller (115), the correlator (117), the profile generator (121), the profile selector (129), the advertisement selector (133), the portal (143), the issuer processor (145), the acquirer processor (147), and the account identification device (141), can be implemented as a computer system, such as a data processing system (170) illustrated in FIG. 7. Some of the components may share hardware or be combined on a computer system. In one embodiment, a network of computers can be used to implement one or more of the components.

Further, the data illustrated in the figures, such as transaction data (109), account data (111), transaction profiles (127), and advertisement data (135), can be stored in storage devices of one or more computers accessible to the corresponding components. For example, the transaction data (109) can be stored in the data warehouse (149) that can be implemented as a data processing system illustrated in FIG. 7, with more or fewer components.

In one embodiment, the transaction handler (103) is a payment processing system, or a payment card processor, such as a card processor for credit cards, debit cards, etc.

FIG. 7 illustrates a data processing system according to one embodiment. While FIG. 7 illustrates various components of a computer system, it is not intended to represent any particular architecture or manner of interconnecting the components. One embodiment may use other systems that have fewer or more components than those shown in FIG. 7.

In FIG. 7, the data processing system (170) includes an inter-connect (171) (e.g., bus and system core logic), which interconnects a microprocessor(s) (173) and memory (167). The microprocessor (173) is coupled to cache memory (179) in the example of FIG. 7.

In one embodiment, the inter-connect (171) interconnects the microprocessor(s) (173) and the memory (167) together and also interconnects them to input/output (I/O) device(s) (175) via I/O controller(s) (177). I/O devices (175) may include a display device and/or peripheral devices, such as mice, keyboards, modems, network interfaces, printers, scanners, video cameras and other devices known in the art. In one embodiment, when the data processing system is a server system, some of the I/O devices (175), such as printers, scanners, mice, and/or keyboards, are optional.

In one embodiment, the inter-connect (171) includes one or more buses connected to one another through various bridges, controllers and/or adapters. In one embodiment the I/O controllers (177) include a USB (Universal Serial Bus) adapter for controlling USB peripherals, and/or an IEEE-1394 bus adapter for controlling IEEE-1394 peripherals.

In one embodiment, the memory (167) includes one or more of: ROM (Read Only Memory), volatile RAM (Random Access Memory), and non-volatile memory, such as hard drive, flash memory, etc.

Volatile RAM is typically implemented as dynamic RAM (DRAM) which requires power continually in order to refresh or maintain the data in the memory. Non-volatile memory is typically a magnetic hard drive, a magnetic optical drive, an optical drive (e.g., a DVD RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In this description, some functions and operations are described as being performed by or caused by software code to simplify description. However, such expressions are also used to specify that the functions result from execution of the code/instructions by a processor, such as a microprocessor.

Alternatively, or in combination, the functions and operations as described here can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

While one embodiment can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system or a specific application, component, program, object, module or sequence of instructions referred to as “computer programs.” The computer programs typically include one or more instructions set at various times in various memory and storage devices in a computer, and that, when read and executed by one or more processors in a computer, cause the computer to perform operations necessary to execute elements involving the various aspects.

A machine readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others. The computer-readable media may store the instructions.

The instructions may also be embodied in digital and analog communication links for electrical, optical, acoustical or other forms of propagated signals, such as carrier waves, infrared signals, digital signals, etc. However, propagated signals, such as carrier waves, infrared signals, digital signals, etc. are not tangible machine readable medium and are not configured to store instructions.

In general, a machine readable medium includes any mechanism that provides (i.e., stores and/or transmits) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

### Other Aspects

The description and drawings are illustrative and are not to be construed as limiting. The present disclosure is illustrative of inventive features to enable a person skilled in the art to make and use the techniques. Various features, as described herein, should be used in compliance with all current and future rules, laws and regulations related to privacy, security, permission, consent, authorization, and others. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

The use of headings herein is merely provided for ease of reference, and shall not be interpreted in any way to limit this disclosure or the following claims.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, and are not necessarily all referring to separate or alternative embodiments mutually exclusive of other embodiments. Moreover, various features are described which may be exhibited by one embodiment and not by others. Similarly, various requirements are described which may be requirements for one embodiment but not other embodiments. Unless excluded by explicit description and/or apparent incompatibility, any combination of various features described in this description is also included here. For example, the features described above in connection with “in one embodiment” or “in some embodiments” can be all optionally included in one implementation, except where the dependency of certain features on other features, as apparent from the description, may limit the options of excluding selected features from the implementation, and incompatibility of certain features with other features, as apparent from the description, may limit the options of including selected features together in the implementation.

The disclosures of the above discussed patent documents are hereby incorporated herein by reference.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

1. A system having at least one microprocessor and memory storing instructions configured to instruct the at least one microprocessor to perform operations, the system comprising:
a transaction handler configured to interconnect issuer processors and acquirer processors in a payment processing network, wherein each of the issuer processors is configured to control consumer accounts issued to consumers and make payments on behalf of the consumers using the consumer accounts and each of the acquirer processors is configured to receive payments on behalf of merchants using merchant accounts set up for the merchants;
a data warehouse configured to store transaction data recording payment transactions processed via the transaction handler;
a profile generator coupled with the data warehouse to generate a transaction profile of a plurality of customers residing in a region identified by a zip+4 postal code, wherein the transaction profile is generated by the profile generator by:
identifying, for the zip+4 postal code, the plurality of customers;
identifying payment transactions of the plurality of customers from the transaction data;
determining, from the payment transactions, an average travel distance between:
residence locations of the plurality of consumers residing in the region identified by the zip+4 postal code, and
retail locations of a plurality of merchants identified from the transaction data, to which merchants the plurality of consumers made card-present payments using consumer accounts issued to the plurality of consumers;
a portal coupled with the data warehouse to provide the transaction profile; and
a search engine in communication with the portal, the search engine configured to receive a search term,
identify a residence region of a user submitting the search term,
receive from the portal the transaction profile identified by the zip+4 postal code, when the residence region corresponds to the zip+4 postal code, and
customize search results for the search term based at least in part on the average travel distance included in the transaction profile.

2. The system of claim 1, wherein the search engine is configured to rank the search results based at least in part on the average travel distance.

3. The system of claim 2, wherein the search results prioritized based on the average travel distance do not include an advertisement.

4. The system of claim 2, wherein the search engine is configured to rank the search results based benefits provided by merchants in the search results.

5. The system of claim 4, wherein the benefits include one of: incentive, discount, and reward.

6. The system of claim 1, wherein the transaction profile includes a spending level indicator generated as a percentile of the zip+4 postal code among zip+4 postal codes in aggregated spending in a predetermined category.

7. The system of claim 1, wherein the transaction profile includes a spending level indicator generated as a normalized index of aggregated spending for the zip+4 postal code and a first category, normalized across a set of categories and normalized across zip+4 postal codes.

8. The system of claim 1, further configured via the instructions to determine, based on the average travel distance, a preferred trading area of the user submitting the search term, and to weight a distance beyond the preferred trading area against criteria of a search associated with the search term.

9. The system of claim 8, wherein the preferred trading area is determined based on the average travel distance and a boundary of the residence region of the user submitting the search term.

10. The system of claim 8, wherein the preferred trading area is determined based on the average travel distance and a center of the residence region of the user submitting the search term.

11. The system of claim 8, wherein the preferred trading area is determined based on the average travel distance and a home location of the user submitting the search term.

12. The system of claim 1, wherein the portal is further configured to communicate with the search engine to measure effectiveness of offers presented via the search engine.

13. The system of claim 12, wherein the search engine is configured to provide the offers to users in a second region without providing the offers to users in a first region that is similar to the second region in transaction profile; and the portal is configured to identify transaction trends relevant to the offers and determine the effectiveness of the offers based on a difference in the transaction trends following delivery of the offers to the users in the second region.

14. The system of claim 1, wherein the search engine is configured to optimize ranking of search results based on measured effect of prioritization.

15. The system of claim 14, wherein users residing in a first region and users residing in a second region similar to the first region in transaction profile are paired to detect effect of parameter adjustments for prioritization; wherein the users residing in the first region are provided with search results without the parameter adjustments, while the users residing in the second regions are provided with search results with the parameter adjustments.

16. The system of claim 15, wherein the portal is configured to monitor transaction trends to determine the effect of the parameter adjustments

17. A computer-implemented method, comprising:
receiving, in a computing device, a search term from a user;
identifying, by the computing device, a region within which a residence location of the user is located;
communicating, by the computing device, with a portal to obtain a spending profile generated based on aggregating transaction data of a plurality of users residing in the region identified by a zip+4 postal code, wherein the spending profile includes an average travel distance between
residence locations of the plurality of users residing in the region identified by the zip+4 postal cod; and
retail locations of a plurality of merchants identified by the transaction data to have received card-present payments made using payment accounts issued to the plurality of consumers; and
customizing, by the computing device, a search result based on the average travel distance provided in the spending profile.

18. The method of claim 17, wherein the spending profile is generated based on transaction data of first users who have residence locations within the region and generated via normalization using transaction data of second users who have residence locations within a plurality of regions different from the region.

19. The method of claim 18, wherein the search result is filtered based on the average travel distance.

20. A non-transitory computer storage media storing instructions configured to instruct a computing device to:
receive, in the computing device, a search term from a user;
identify, by the computing device, a region within which a residence location of the user is located;
communicate, by the computing device, with a portal to obtain a spending profile generated based on aggregating transaction data of a plurality of users residing in the region identified by a zip+4 postal code, wherein the spending profile includes an average travel distance between
residence locations of the plurality of users residing in the region identified by the zip+4 postal code, and
retail locations of a plurality of merchants identified by the transaction data to have received card-present payments made using payment accounts issued to the plurality of consumers; and
customize, by the computing device, a search result based on the average travel distance provided in the spending profile.
